(19) United States
(12) Patent Application Publication
(10) Pub. No.: US 2026/0259463 A1
(43) Pub. Date: Sep. 3, 2026

(54) LIQUID CRYSTAL DISPLAY PANEL AND LIQUID CRYSTAL DISPLAY APPARATUS COMPRISING THE SAME

(71) Applicant: LG Display Co., Ltd., Seoul (KR)

(72) Inventors: Uihyeon JEONG, Paju-si (KR); Seung Ryong LEE, Paju-si (KR); HyeJeong PARK, Paju-si (KR); Wonjin CHOI, Paju-si (KR); ByungGwan HYUN, Paju-si (KR)

(21) Appl. No.: 19/428,291

(22) Filed: Dec. 21, 2025

(30) Foreign Application Priority Data
Feb. 28, 2025 (KR) 10-2025-0026960

(51) Int. Cl. G02F 1/1368; G02F 1/1333; G02F 1/1335; G02F 1/13357; G02F 1/1343; G02F 1/1362

(52) U.S. Cl. CPC G02F 1/1368; G02F 1/133357; G02F 1/133514; G02F 1/133602; G02F 1/134309; G02F 1/136286

(57) ABSTRACT

A liquid crystal display panel includes a front substrate including a plurality of pixel areas, a rear substrate including color filters corresponding to each of the plurality of pixel areas, and a liquid crystal layer disposed between the front substrate and the rear substrate. The front substrate includes a base substrate, a vibration generating part disposed on the base substrate, a planarization layer configured to cover the vibration generating part in a thickness direction, and a pixel array layer disposed on the planarization layer.

### CROSS REFERENCE TO RELATED APPLICATION

This application claims priority from and the benefit of Korean Patent Application No. 10-2025-0026960, filed on Feb. 28, 2025, which is hereby incorporated by reference for all purposes as if fully set forth herein.

### BACKGROUND

### Field

Embodiments of the invention relate generally to a liquid crystal display apparatus, and more particularly, to a liquid crystal display panel configured to output a sound and a liquid crystal display apparatus including the same.

### Discussion of the Background

Liquid crystal display apparatuses are equipped in home appliances or electronic devices, such as televisions (TVs), monitors, notebook computers, smartphones, tablet computers, electronic organizers, electronic pads, wearable devices, watch phones, portable information devices, navigation devices, and automotive control display apparatuses, and are used as a screen for displaying an image.

In the liquid crystal display apparatus, a display panel displays an image, and a separate speaker should be installed for providing a sound generally. In a case where a speaker is disposed in the liquid crystal display apparatus, the speaker occupies a space, and due to this, the design and spatial disposition of the liquid crystal display apparatus are limited.

The above information disclosed in this Background section is only for understanding of the background of the inventive concepts, and, therefore, it may contain information that does not constitute prior art.

### SUMMARY

Liquid crystal display (LCD) panels and liquid display apparatuses including the same according to embodiments of the invention are capable of outputting a sound.

Display panels and display apparatuses including the same according to embodiments of the invention are also capable of outputting a sound.

Additional features of the inventive concepts will be set forth in the description which follows, and in part will be apparent from the description, or may be learned by practice of the inventive concepts.

According to an embodiment of the present disclosure, a liquid crystal display panel includes: a front substrate including a plurality of pixel areas; a rear substrate including color filters corresponding to each of the plurality of pixel areas; and a liquid crystal layer disposed between the front substrate and the rear substrate, in which the front substrate includes: a base substrate; a vibration generating part disposed on the base substrate; a planarization layer to cover the vibration generating part in a thickness direction; and a pixel array layer disposed on the planarization layer. The vibration generating part may include a piezoelectric vibration layer having a piezoelectric material.

The vibration generating part may include: a first electrode layer disposed on the base substrate; a piezoelectric vibration layer including a piezoelectric material and disposed on the first electrode layer; and a second electrode layer disposed on the piezoelectric vibration layer.

The pixel array layer may include a plurality of gate lines and a plurality of data lines which are disposed on the planarization layer configured to intersect each other and to define the plurality of pixel areas, and the vibration generating part may overlap the plurality of gate lines and the plurality of data lines.

The vibration generating part may include: a plurality of first lines overlapping each of the plurality of data lines; and a plurality of second lines overlapping each of the plurality of gate lines and intersecting the plurality of first lines.

The plurality of first lines and the plurality of second lines may be disposed on a same layer to have a mesh shape connected to each other.

Each of the plurality of first lines and the plurality of second lines may include: a first electrode layer disposed on the base substrate; a piezoelectric vibration layer including a piezoelectric material disposed on the first electrode layer; and a second electrode layer disposed on the piezoelectric vibration layer.

The pixel array layer further may include: a plurality of thin-film transistors disposed in each of the plurality of pixel areas and configured to be electrically connected to adjacent data lines and adjacent gate lines; a plurality of pixel electrodes disposed in each of the plurality of pixel areas and configured to be electrically connected to a corresponding thin-film transistor of the plurality of thin-film transistors; and a common electrode overlapping the plurality of pixel electrodes.

The common electrode may be divided into a plurality of touch electrodes overlapping one or more of the plurality of pixel areas.

The vibration generating part may include a plurality of protrusions that are protruded from intersection portions of the plurality of first lines and the plurality of second lines and overlap each of the plurality of thin-film transistors, and each of the plurality of protrusions may include the first electrode layer, the piezoelectric vibration layer, and the second electrode layer.

The front substrate may include: a first area overlapping the rear substrate; a second area extending from the first area; and a pad part disposed in the second area. The vibration generating part may overlap the pad part.

The pad part may include: a plurality of first pads electrically connected to each of the plurality of data lines; a plurality of second pads electrically connected to the first electrode layer of each of the plurality of first lines; and a plurality of third pads electrically connected to the second electrode layer of each of the plurality of first lines.

The vibration generating part may further include an electrode protrusion protruded from one side of the first electrode layer of each of the plurality of first lines, and the plurality of second pads may be electrically connected to the electrode protrusion.

The piezoelectric vibration layer may include: two or more piezoelectric layers configured between the first electrode layer and the second electrode layer; and at least one intermediate electrode layer disposed between the two or more piezoelectric layers.

The pad part may include: a plurality of first pads electrically connected to each of the plurality of data lines; a plurality of second pads commonly and electrically connected to the first electrode layer and the second electrode layer of each of the plurality of first lines; and a plurality of third pads electrically connected to the intermediate electrode layer of each of the plurality of first lines.

The liquid crystal display panel further includes: a based substrate disposed on the front substrate; and a reflection reducing part disposed between the base substrate and the vibration generating part, in which the reflection reducing part is made of a light-blocking material and includes a same shape as the vibration generating part in a plan view.

According to another embodiment of the present disclosure, a display apparatus includes: a display panel including a front substrate including a plurality of pixel areas, a rear substrate including color filters corresponding to each of the plurality of pixel areas, an electro-optical layer disposed between the front substrate and the rear substrate; a backlight unit configured to irradiate light to the display panel; and a panel driving circuit electrically connected to the display panel, in which the front substrate includes: a base substrate; a vibration generating part disposed on the base substrate; a planarization layer to cover the vibration generating part in a thickness direction; and a pixel array layer disposed on the planarization.

The display panel may further include a reflection reducing part disposed between the base substrate and the vibration generating part, and the reflection reducing part may be made of a light-blocking material and include a same shape as the vibration generating part in a plan view.

The panel driving circuit may include an amplifier circuit configured to apply a vibration driving signal to the vibration generating part which is disposed in the display panel.

The vibration generating part may be displaced based on the vibration driving signal, and the front substrate may vibrate based on the displacement of the vibration generating part to generate one or more of a sound and a haptic vibration.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a schematic perspective view illustrating a liquid crystal display device according to an embodiment of the present disclosure.

FIG. 2 is a schematic cross-sectional view taken along line I–I’ of FIG. 1.

FIG. 3 is a schematic plan view illustrating a liquid crystal display panel and a driving circuit part illustrated in FIG. 2.

FIG. 4 is a schematic plan view illustrating one pixel illustrated in FIG. 3.

FIG. 5 is a schematic cross-sectional view taken along line II–II’ of FIG. 4.

FIG. 6 is another schematic cross-sectional view taken along line II–II’ of FIG. 4.

FIG. 7 is a schematic cross-sectional view taken along line III–III’ of FIG. 3.

FIG. 8 is a schematic plan view illustrating a portions of each of a vibration generating part and a pad part according to an embodiment of the present disclosure.

FIG. 9 is a schematic perspective view illustrating a portion of the vibration generating part illustrated in FIG. 8.

FIG. 10 is a schematic cross-sectional view taken along line IV–IV’ of FIG. 8.

FIG. 11 is a schematic plan view illustrating a portion of each of a vibration generating part and a pad part according to another embodiment of the present disclosure.

FIG. 12 is a schematic perspective view illustrating a portion of the vibration generating part illustrated in FIG. 11.

FIG. 13 is a schematic cross-sectional view taken along line V–V’ of FIG. 11.

FIG. 14 is a schematic plan view illustrating a portion of each of a vibration generating part and a pad part according to another embodiment of the present disclosure.

FIG. 15 is a schematic cross-sectional view taken along line VI–VI’ of FIG. 14.

Throughout the drawings and the detailed description, unless otherwise described, the same drawing reference numerals should be understood to refer to the same elements, features, and structures. The sizes, lengths, and thicknesses of layers, regions and elements, and depiction of thereof may be exaggerated for clarity, illustration, and convenience.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z – axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

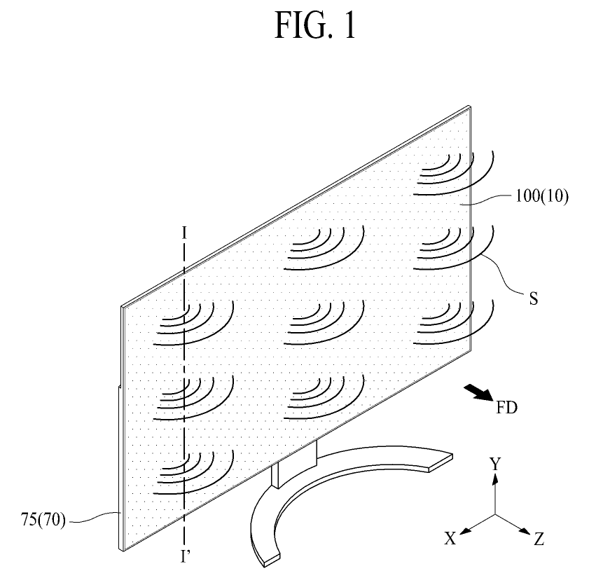

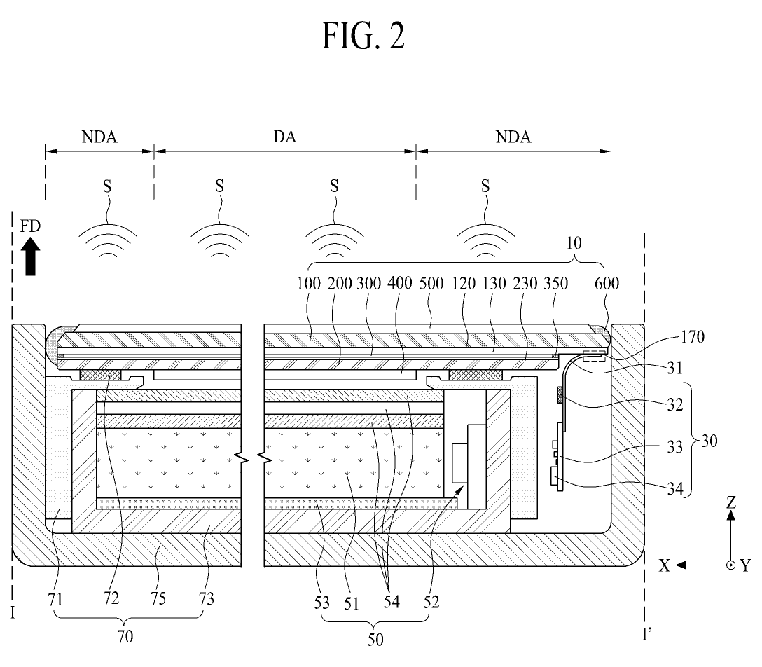

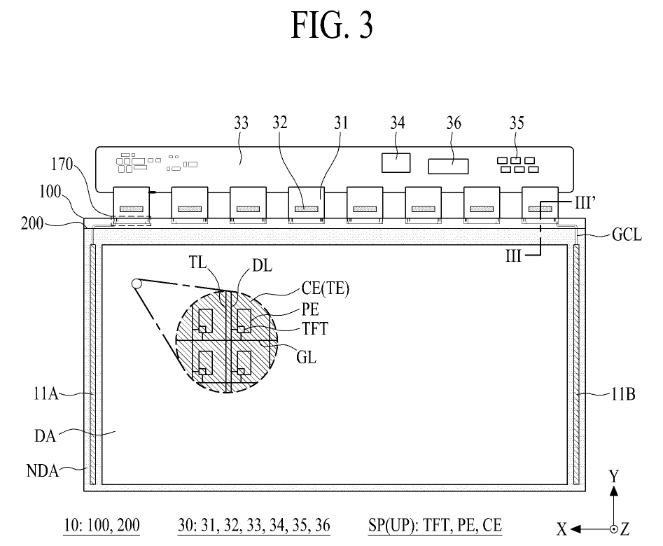

FIG. 1 is a schematic perspective view illustrating a liquid crystal display device according to an embodiment of the present disclosure. FIG. 2 is a schematic cross-sectional view taken along line I–I’ of FIG. 1. FIG. 3 is a schematic plan view illustrating a liquid crystal display panel and a driving circuit part illustrated in FIG. 2.

Referring to FIGS. 1, 2, and 3, the liquid crystal display apparatus according to an embodiment of the present disclosure includes a liquid crystal display panel 10.

The liquid crystal display panel 10 may display an image and output a sound based on a vibration (or a self-vibration). For example, the liquid crystal display panel 10 may display an image and simultaneously output a sound based on a vibration (or a self-vibration).

The liquid crystal display panel 10 may include a front substrate 100, a rear substrate 200, and an electro-optical layer, such as a liquid crystal layer 300. The liquid crystal layer 300 may be disposed between the front substrate 100 and the rear substrate 200.

The front substrate 100 may be a first substrate, an external substrate, a thin-film transistor array substrate, or a screen. The front substrate 100 may include a display area DA and a non-display area NDA. The display area DA may be disposed adjacent to the non-display area NDA.

The display area DA may be an area where an image is displayed. For example, the display area DA may be a screen. The non-display area NDA may include an edge area of the front substrate 100 surrounding the display area DA.

The front substrate 100 may include a vibration generating part 130. The vibration generating part 130 may include a piezoelectric vibration layer including a piezoelectric material. The vibration generating part 130 may vibrate the front substrate 100 or the liquid crystal display panel 10 based on a vibration (or displacement or driving) of the piezoelectric vibration layer. Accordingly, the front substrate 100 or the liquid crystal display panel 10 may vibrate based on the vibration of the vibration generating part 130 configured to to output a sound S in a front direction FD. For example, the sound S may be output from a screen of the liquid crystal display panel 10 toward the front direction FD of the liquid crystal display panel 10. Thus, a user sitting in front of the liquid crystal display panel 10 may hear the sound S.

The vibration generating part 130 may be configured between the front substrate 100 and the rear substrate 200 and may be covered by a planarization layer which is formed at the front substrate 100.

The front substrate 100 or the display area DA may further include a pixel array layer disposed on the planarization layer.

The pixel array layer may include a plurality of gate lines GL and a plurality of data lines DL which are disposed on the planarization layer to intersect each other and configured to define a plurality of pixel areas, and a plurality of pixels SP which are disposed in each pixel area provided by intersections of the plurality of gate lines GL and the plurality of data lines DL.

Each of the plurality of pixels SP may be a subpixel configuring one unit pixel (or a single unit pixel) UP. For example, the one unit pixel UP may include a red subpixel, a green subpixel, and a blue subpixel, but is not limited thereto, and may further include a white subpixel.

Each of the plurality of pixels SP may be disposed in each of the plurality of pixel areas and may include a plurality of thin-film transistors TFT configured to be electrically connected to adjacent data lines DL and adjacent gate lines GL. Each of the plurality of pixels SP may include a pixel electrode PE configured to be electrically connected to the thin-film transistor TFT and a common electrode CE configured to overlap the pixel electrode PE.

The common electrode CE may be divided into a plurality of touch electrodes TE overlapping one or more of the plurality of pixel areas. The plurality of touch electrodes TE may overlap one or more pixel areas based on a touch resolution. Each of the plurality of touch electrodes TE may be electrically connected to a corresponding touch line TL among a plurality of touch lines (or common voltage lines) TL.

The vibration generating part 130 may overlap the plurality of gate lines GL and the plurality of data lines DL. The vibration generating part 130 may overlap each of the plurality of gate lines GL, the plurality of data lines DL, and the plurality of touch lines TL. For example, the vibration generating part 130 may have a line width wider than each of the plurality of gate lines GL, the plurality of data lines DL, and the plurality of touch lines TL.

The rear substrate 200 may be a second substrate, an inner substrate, or a color filter array substrate. The rear substrate 200 may cover a portion of the front substrate 100. The rear substrate 200 may have a smaller size (or area) than the front substrate 100. For example, the rear substrate 200 may have a size corresponding to a remaining portion of the front substrate 100 except for one side edge portion of the front substrate 100.

The rear substrate 200 may include a color filter layer 230. The color filter layer 230 may include color filters configured to overlap the pixel area of each of the plurality of pixels SP provided on the front substrate 100.

The front substrate 100 may further include a first area overlapping the rear substrate 200, a second area extending from the first area, and a pad part 170 disposed in the second area.

The pad part 170 may be disposed in one side edge portion (or the second area) extending from one side of the display area DA.

The pad part 170 may be electrically connected to each of the plurality of data lines DL disposed in the pixel array layer. The pad part 170 may supply (or transmit) a data signal (or a data voltage) to each of the plurality of data lines DL. The pad part 170 may be electrically connected to the vibration generating part 130. The pad part 170 may supply (or transmit) a vibration driving signal (or a voice signal) to the vibration generating part 130.

The pad part 170 may be electrically connected to each of the plurality of touch lines TL. The pad part 170 may supply (or transmit) a touch driving signal (or a touch driving pulse or a common voltage) to each of the plurality of touch lines TL.

The front substrate 100 may further include gate driving circuits 11A and 11B. In an embodiment, the gate driving circuits 11A and 11B may be disposed in the non-display area NDA.

The gate driving circuits 11A and 11B may be formed at non-display area NDA in one side or both sides of short sides of the front substrate 100 together with the manufacturing process of thin-film transistors TFT of each pixel SP, and may be electrically connected to each of the plurality of gate lines GL formed in the display area DA. The gate driving circuits 11A and 11B may be electrically connected to the pad part 170 through a gate control signal line GCL. The gate driving circuits 11A and 11B may generate a gate signal (or scan signal) based on a gate control signal supplied through the pad part 170 and the gate control signal line GCL, and supply the gate signal to a corresponding gate line GL. For example, the gate driving circuits 11A and 11B may be configured as shift registers including transistors formed by a same process as the thin-film transistors TFT provided in each pixel SP.

Referring to FIG. 2, the rear substrate 200 may be bonded to the remaining portion (or first area) of the front substrate 100, except for one side edge portion (or the second area), with the liquid crystal layer 300 therebetween by a sealant 350. For example, the sealant 350 may be disposed (or interposed) between an edge portion of the rear substrate 200 and the front substrate 100.

The liquid crystal layer 300 may be interposed (or filled) between the front substrate 100 and the rear substrate 200. The liquid crystal layer 300 may be formed of liquid crystal in which the alignment direction of liquid crystal molecules changes based on an electric field formed by a data voltage applied to the pixel electrode PE for each pixel and a common voltage applied to the common electrode CE.

The liquid crystal display panel 10 may further include a first polarizing member 400 and a second polarizing member 500. The front substrate 100, the rear substrate 200, and the liquid crystal layer 300 may be disposed between the first polarizing member 400 and the second polarizing member 500. The first polarizing member 400 may be attached to a rear (or bottom) surface of the rear substrate 200. The first polarizing member 400 may polarize light incident on the liquid crystal layer 300. The second polarizing member 500 may be attached to a front (or top) surface of the front substrate 100. The second polarizing member 500 may polarize light emitted an outside through the front substrate 100.

The liquid crystal display panel 10 may drive the liquid crystal layer 300 according to an electric field which is formed for each pixel SP by the data voltage and the common voltage applied to each pixel SP, and thus, may display an image based on light passing through the liquid crystal layer 300.

In the liquid crystal display panel 10 according to an embodiment of the present disclosure, since the front substrate 100 configures an image display surface (or a screen), an entire front of the liquid crystal display panel 10 may be exposed at the outside without being a portion covered by a separate mechanism. Accordingly, a bezel forming a border of the liquid crystal display apparatus may be completely omitted, or even if the bezel is formed, a bezel width may be very small, and thus, an entire design aesthetics of the liquid crystal display apparatus may be improved.

Referring to FIGS. 2 and 3, the liquid crystal display panel 10 according to an embodiment of the present disclosure may further include an edge sealing member 600.

The edge sealing member 600 may be formed to surround at least one or more lateral sides of the liquid crystal display panel 10. The edge sealing member 600 may be formed to cover each lateral side and each corner of the liquid crystal display panel 10. The edge sealing member 600 may protect the lateral sides of the liquid crystal display panel 10 from external impact or to prevent side light leakage of the liquid crystal display panel 10. For example, the edge sealing member 600 may be made of a colored resin or light-blocking resin to prevent the side light leakage.

The liquid crystal display apparatus according to an embodiment of the present disclosure may further include a panel driving circuit 30.

The panel driving circuit 30 may display an image on the liquid crystal display panel 10 and vibrate the vibration generating part 130 provided in the liquid crystal display panel 10. The panel driving circuit 30 may be electrically connected to the pad part 170 provided at the front substrate 100 of the liquid crystal display panel 10. The panel driving circuit 30 may apply the data signal to the plurality of data lines DL through the pad part 170, apply the gate control signal to the gate driving circuits 11A and 11B through the pad part 170 and the gate control signal line GCL, and apply the vibration driving signal to the vibration generating part 130 through the pad part 170.

The panel driving circuit 30 may include a plurality of flexible circuit films 31, a data driving integrated circuit 32, a printed circuit board 33, and a timing controller 34.

Each of the plurality of flexible circuit films 31 may be attached to the pad part 170 and the printed circuit board 33. For example, one end of each of the plurality of flexible circuit films 31 may be electrically connected to the pad part 170 by a reverse bonding scheme, and another end of each of the plurality of flexible circuit films 31 may be electrically connected to the circuit board 33. Accordingly, each of the plurality of flexible circuit films 31 may not protrude in a lateral direction of the front substrate 100. A first and/or last flexible circuit films 31 among the plurality of flexible circuit films 31 may be electrically connected to the gate driving circuits 11A and 11B through the pad part 170.

The data driving integrated circuit 32 may be mounted on each of the plurality of flexible circuit films 31. The data driving integrated circuit 32 may convert digital image data input from the timing controller 34 through the printed circuit board 33 into analog data signals and supply the analog data signals to corresponding data lines DL through the pad part 170.

The data driving integrated circuit 32 may be electrically connected to each of a plurality of touch electrodes TE through each of a plurality of touch lines TL. Each of the plurality of touch electrodes TE may be electrically connected to a corresponding touch line TL among the plurality of touch lines TL.

The data driving integrated circuit 32 may apply a common voltage to the plurality of touch electrodes TE during a display period, and apply the touch driving signal (or the touch driving pulse) to each of the plurality of touch electrodes TE during a touch sensing period. For example, in the touch sensing period, the data driving integrated circuit 32 may apply the touch driving signal to the plurality of touch electrodes TE, and output touch raw data by detecting a change in capacitance of each of the plurality of touch electrodes TE. For example, the data driving integrated circuit 32 may detect changes in capacitance of each of the plurality of touch electrodes TE based on a self-capacitance method, but is not limited thereto.

The printed circuit board 33 may be electrically connected to the other side of each of the plurality of flexible circuit films 31 and configured to transmit signals needed for driving the liquid crystal display panel 10 to corresponding flexible circuit films 31.

The timing controller 34 may be mounted on the printed circuit board 33. For example, the timing controller 34 may control driving of the data driving integrated circuit 32 and the gate driving circuits 11A and 11B and provide digital image data input from the outside to corresponding data driving integrated circuits 32.

The timing controller 34 may generate touch position data based on the touch raw data provided from the data driving integrated circuit 32 and provide the touch position data to a host controller.

The panel driving circuit 30 may further include a power circuit 35 that generates various power (or driving voltages) needed for driving the liquid crystal display panel 10, and a memory device, or the like.

The panel driving circuit 30 may further include a vibration driving circuit 36.

The vibration driving circuit 36 may be mounted on the printed circuit board 33. The vibration driving circuit 36 may vibrate the vibration generating part 130 disposed in the liquid crystal display panel 10 or at the front substrate 100. The vibration driving circuit 36 may generate a vibration driving signal based on input sound source data. For example, the vibration driving circuit 36 may include a sound processing circuit that generates a sound signal from the sound source data, and an amplifier circuit that amplifies the sound signal and outputs the vibration driving signal. For example, the amplifier circuit may include a pre-amplifier circuit and a main amplifier circuit. Accordingly, the vibration generating part 130 may vibrate based on the vibration driving signal, and the front substrate 100 or the liquid crystal display panel 10 may vibrate based on a vibration of the vibration generating part 130 to generate (or output) one or more of a vibration and a sound S. For example, when the vibration generating part 130 vibrates, one or more of the vibration and the sound S may be generated (or output) in areas corresponding to each of the plurality of gate lines GL and the plurality of data lines DL.

The vibration driving circuit 36 may vibrate the vibration generating part 130 in response to a haptic data provided from a display host controller or the timing controller 34. For example, the vibration driving circuit 36 may generate a haptic vibration signal corresponding to the haptic data. Accordingly, the vibration generating part 130 may vibrate based on the haptic vibration signal, and the front substrate 100 or the liquid crystal display panel 10 may vibrate based on the haptic vibration of the vibration generating part 130 to generate (or output) a haptic texture and/or a haptic feedback vibration in response to a touch of user.

The liquid crystal display apparatus may further include a backlight unit 50.

The backlight unit 50 may irradiate light to the liquid crystal display panel 10. The backlight unit 50 may be disposed below the rear substrate 200 of the liquid crystal display panel 10 and configured to irradiate light to the rear substrate 200. The backlight unit 50 may include a light guide plate 51, a light source 52, a reflective sheet 53, and an optical sheet member 54.

The light guide plate 51 may be formed in a plate shape (or wedge shape) and configured to guide light incident from the light source 52 through an incident surface toward the liquid crystal display panel 10. The light source 52 may be disposed to face the incident surface provided on at least one side surface of the light guide plate 51 and configured to irradiate light on the light guide plate 51. The light source 52 may include a plurality of light emitting diodes. The reflective sheet 53 may be disposed on a lower surface of the light guide plate 51 and configured to reflect light incident from the light guide plate 51 toward the liquid crystal display panel 10. The optical sheet member 54 may be disposed on the light guide plate 51 and configured to improve the luminance characteristics of light traveling from the light guide plate 51 toward the liquid crystal display panel 10. For example, the optical sheet member 54 may be configured as one or more diffusion sheets and one or more prism sheets, or may be configured as a composite functional sheet that simultaneously performs functions of diffusing and condensing light.

The liquid crystal display apparatus may further include a panel support 70.

The panel support 70 may accommodate the backlight unit 50 and the panel driving circuit 30, and may be coupled to a rear edge portion of the liquid crystal display panel 10 so that an entire front of the liquid crystal display panel 10 is exposed the outside. The panel support 70 may include a guide frame 71, a panel coupling member 72, a supporting case 73, and a rear cover 75.

The guide frame 71 may be formed in a rectangular frame shape to support the rear edge portion of the liquid crystal display panel 10 and may be coupled to the rear edge portion of the liquid crystal display panel 10 through the panel coupling member 72, but is not limited thereto, and may also be coupled to the first polarizing member 400 of the liquid crystal display panel 10. The panel coupling member 72 may include a double-sided tape, a thermosetting adhesive, or a photo-curable adhesive.

The supporting case (or a supporting cover) 73 may be formed to have an accommodating space. The supporting case 73 may support (or accommodate) the backlight unit 50 and the guide frame 71. Lateral surfaces of the supporting case 73 may be surrounded by the guide frame 71. In another example, the supporting case 73 may be omitted depending on an appearance design, lightening, or sliming of the liquid crystal display apparatus.

The rear cover 75 may have an accommodating space. The rear cover 75 may accommodate the supporting case 73 and be configured to surround the guide frame 71 and lateral surfaces of the liquid crystal display panel 10 so that the entire front of the liquid crystal display panel 10 is exposed the outside. For example, the rear cover 75 may be made of a plastic material or a metal material.

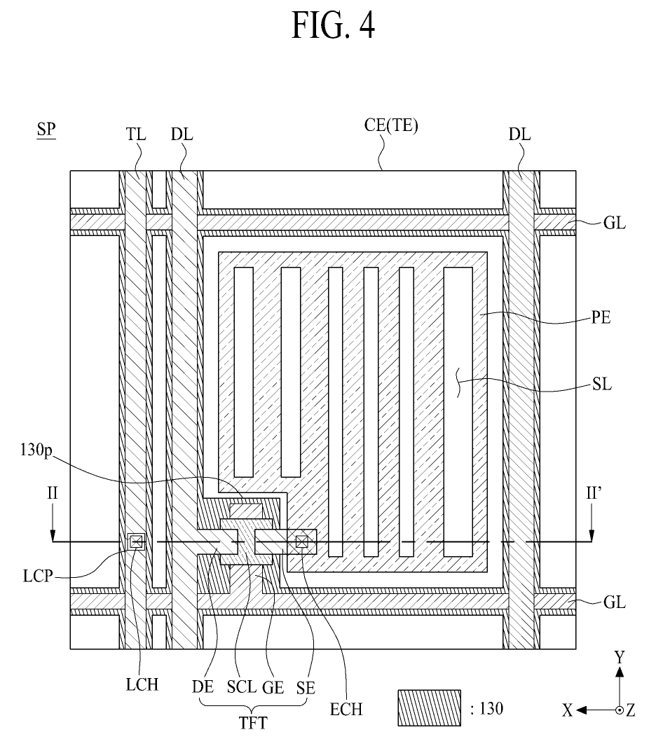

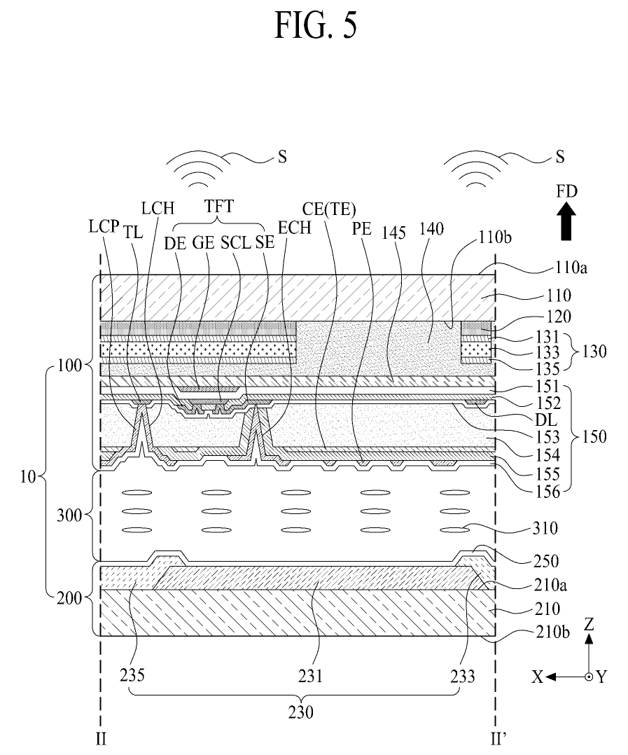

FIG. 4 is a schematic plan view illustrating one pixel illustrated in FIG. 3. FIG. 5 is a schematic cross-sectional view taken along line II–II’ of FIG. 4. Hereinafter, the liquid crystal display panel 10 according to an embodiment of the present disclosure will be described with reference to FIGS. 4 and 5.

The liquid crystal display panel 10 may be driven in a fringe field switching method in which a fringe field formed between the common electrode CE and the pixel electrode PE passes through the slit SL and drives the liquid crystal molecule 310 of the liquid crystal layer 300 positioned on the pixel area to implement an image. The liquid crystal display panel 10 according to another embodiment may be driven in a plane switching (or a horizontal electric field switching) method in which an image is implemented by driving the liquid crystal molecule 310 of the liquid crystal layer 300 by a horizontal electric field formed between the common electrode CE and the pixel electrode PE, which are spaced apart from each other and disposed in parallel.

The liquid crystal display panel 10 according to an embodiment of the present disclosure may vibrate based on the vibration of the vibration generating part 130 and output one or more of the sound S and the vibration in the front direction FD, thereby outputting the sound S or displaying an image while outputting the sound S.

Referring to FIGS. 4 and 5, the liquid crystal display panel 10 according to an embodiment of the present disclosure may include the front substrate 100 and the rear substrate 200.

The front substrate 100 may include a base substrate 110, a vibration generating part 130, a planarization layer 140, and a pixel array layer 150.

The base substrate 110 may be made of glass or transparent plastic. The base substrate 110 may include a front (or top) surface 110a and a rear (or bottom) surface 110b. A front surface 110a of the base substrate 110 may be a front (or top) surface of the liquid crystal display panel 10.

The vibration generating part 130 may be disposed on the base substrate 110. The vibration generating part 130 may be disposed on a rear (or bottom) surface 110b of the base substrate 110. The vibration generating part 130 may vibrate the base substrate 110 or the front substrate 100. The vibration generating part 130 may correspond to remaining areas except for an opening region of each of the plurality of pixel areas. The vibration generating part 130 may have a mesh shape corresponding to the remaining areas except for the opening region of each of the plurality of pixel areas.

The vibration generating part 130 may include a first electrode layer 131, a piezoelectric vibration layer 133, and a second electrode layer 135.

The first electrode layer 131 may be disposed on the base substrate 110. For example, the first electrode layer 131 may be disposed on a rear (or bottom) surface of the base substrate 110.

The piezoelectric vibration layer 133 may be disposed on the first electrode layer 131. The piezoelectric vibration layer 133 may be stacked (or coupled) on the first electrode layer 131 to have a same shape as the first electrode layer 131.

The piezoelectric vibration layer 133 may include a piezoelectric material or an electroactive material which includes a piezoelectric effect. The piezoelectric vibration layer 133 may include at least one or more of a piezoelectric inorganic material and a piezoelectric organic materials. For example, the piezoelectric material may have a characteristic in which, when pressure or twisting phenomenon is applied to a crystalline structure by an external force, a potential difference occurs due to dielectric polarization caused by a relative position change of a positive (+) ion and a negative (-) ion, and a vibration is generated by an electric field based on a reverse voltage applied thereto. For example, the piezoelectric vibration layer 133 may be a piezoelectric layer, a piezoelectric material layer, an electroactive layer, a piezoelectric composite layer, a piezoelectric composite, or a piezoelectric ceramic composite, or the like, but is not limited thereto.

The piezoelectric vibration layer 133 may be configured as a ceramic-based material for implementing a relatively strong vibration, or may be configured as a piezoelectric ceramic having a perovskite-based crystalline structure. The perovskite crystalline structure may have a piezoelectric effect and/or an inverse piezoelectric effect and may be a plate-shaped structure having an orientation.

The piezoelectric ceramic may be configured as a single crystalline ceramic having a crystalline structure, or may be configured as a ceramic material having a polycrystalline structure or polycrystalline ceramic. A piezoelectric material of the single crystalline ceramic may include α-AlPO₄, α-SiO₂, LiNbO₃, Tb₂(MoO₄)₃, Li₂B₄O₇, or ZnO. A piezoelectric material of the polycrystalline ceramic may include a lead zirconate titanate (PZT)- based material, including lead (Pb), zirconium (Zr), and titanium (Ti), or may include a lead zirconate nickel niobate (PZNN)-based material, including lead (Pb), zirconium (Zr), nickel (Ni), and niobium (Nb). For example, the piezoelectric vibration layer 133 may include at least one or more of calcium titanate (CaTiO₃), barium titanate (BaTiO₃), and strontium titanate (SrTiO₃), without lead (Pb).

The piezoelectric vibration layer 133 may be formed (or configured) by a process forming (or depositing) a piezoelectric material layer (or piezoelectric ceramic layer) on the base substrate 110, a process patterning the piezoelectric material layer, and a heat treatment process, or the like. For example, the piezoelectric material layer may be formed (or configured) by a physical deposition process such as a sputtering process or the like, a chemical vapor deposition process, a sol-gel process using piezoelectric ceramic powder, or a coating process using piezoelectric ceramic powder. The piezoelectric material layer may be patterned by a dry etching process, a wet etching process, or a lift-off process.

According to another embodiment of the present disclosure, the piezoelectric vibration layer 133 may be formed (or configured) on the first electrode layer 131 by a tape casting process (or method). For example, the piezoelectric vibration layer 133 may be formed (or manufactured) through a step of preparing a slurry including piezoelectric powder (or ceramic powder) and an additive, a step of coating (or tape casting or forming) the slurry on the first electrode layer 131, and a step of molding (or sintering) the coated (or formed) slurry at least once. For example, the additive added to the slurry may include a material or a substance known to those skilled in the art of a piezoelectric material composition field. For example, the additive may include one or more of a dispersant, a solvent, a binder, and a plasticizer, but is not limited thereto.

The binder may include a high-temperature binder. For example, the binder may include a glass frit. The binder may remain in a particle state on the first electrode layer 131 in drying of the slurry. The binder may change to a liquid state when piezoelectric particles (or ceramic particles) grows at a molding (or sintering) temperature of the slurry, move to an interface between the first electrode layer 131 and the piezoelectric material, may be solidified based on a reduction in a molding temperature, and may increase a coupling force (or an adhesive force) between the first electrode layer 131 and the piezoelectric material.

The piezoelectric vibration layer 133 according to another embodiment of the present disclosure may be formed on the first electrode layer 131 by the tape casting method, and thus, the piezoelectric vibration layer 133 may not limited to a specific shape and may be formed in a polygonal shape, a non-rectangular shape, or a line shape.

The second electrode layer 135 may be disposed on the piezoelectric vibration layer 133. The second electrode layer 135 may be stacked (or coupled) on the piezoelectric vibration layer 133 to have a same shape as the piezoelectric vibration layer 133.

According to an embodiment of the present disclosure, to prevent electrical connection (or short circuit) between the first electrode layer 131 and the second electrode layer 135, one or more of the first electrode layer 131 and the second electrode layer 135 may be formed on a remaining portion of the piezoelectric vibration layer 133 except for an edge portion thereof.

Each of the first electrode layer 131 and the second electrode layer 135 may be made of a transparent conductive material, a semi-transparent conductive material, or an opaque conductive material. For example, the transparent or semi-transparent conductive material may include ITO (indium tin oxide) or IZO (indium zinc oxide), but is not limited thereto. The opaque conductive material may include or may be made of aluminum (Al), copper (Cu), gold (Au), silver (Ag), platinum (Pt), palladium (Pd), molybdenum (Mo), magnesium (Mg), carbon, or silver (Ag) containing glass frit, or the like, or may include or may be made of an alloy thereof, but is not limited thereto. For example, the glass frit may include PbO-based materials or Bi2O3-based materials, but is not limited thereto. For example, each of the first electrode layer 131 and the second electrode layer 135 may include silver (Ag) having a low resistivity to enhance an electrical characteristic and/or a vibration characteristic of the piezoelectric vibration layer 133. For example, carbon may be carbon black, Ketjenblack, carbon nanotube, and a carbon material including graphite, but is not limited thereto.

The piezoelectric vibration layer 133 may be polarized (or poled) by a polarization voltage applied to the first electrode layer 131 and the second electrode layer 135 through the pad part 170 in a certain temperature atmosphere, or a temperature atmosphere that may be changed from a high temperature to a room temperature.

The piezoelectric vibration layer 133 may alternately and repeatedly contract or expand based on a reverse piezoelectric effect according to the vibration driving signal (or voice signal) applied to the first electrode layer 131 and the second electrode layer 135 through the pad part 170 to vibrate. For example, the piezoelectric vibration layer 133 may vibrate in a vertical direction (or thickness direction) and a planar direction based on the signal applied to the first electrode layer 131 and the second electrode layer 135. The piezoelectric vibration layer 133 may displace (or vibrate or drive) due to contraction or expansion in the planar direction, thereby improving a sound characteristic and/or a sound pressure level characteristic of sound generated based on the vibration of the vibration generating part 130 or the front substrate 100.

The planarization layer 140 may be formed (or configured) on the base substrate 110 to cover the vibration generating part 130. The planarization layer 140 may be an insulating layer for forming (or configuring) a flat surface on the vibration generating part 130. The planarization layer 140 may be made of a high heat-resistant organic material. For example, the planarization layer 140 may include a transparent polyimide material or a siloxane material.

The pixel array layer 150 may be formed (or configured) on the planarization layer 140.

At least one buffer layer 145 may additionally be formed (or configured) between the pixel array layer 150 and the planarization layer 140. The at least one buffer layer 145 may be formed on the planarization layer 140. The at least one buffer layer 145 may be made of an inorganic material. In another example, a plurality of buffer layers 145 may be made of different inorganic materials.

The pixel array layer 150 may include a plurality of gate lines GL and a plurality of data lines DL which are disposed on the planarization layer 140 (or buffer layer 145) to intersect each other and configured to define a plurality of pixel areas. Each of the plurality of gate lines GL and the plurality of data lines DL may be formed (or disposed) on the planarization layer 140 (or buffer layer 145) to overlap the vibration generating part 130.

The pixel array layer 150 may include a plurality of thin-film transistors TFT, a common electrode CE, and a plurality of pixel electrodes PE.

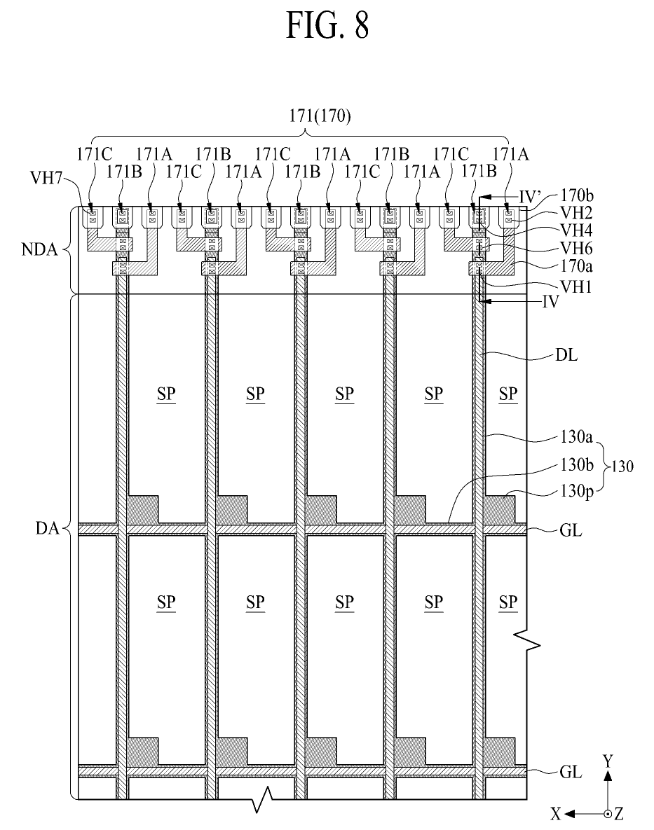

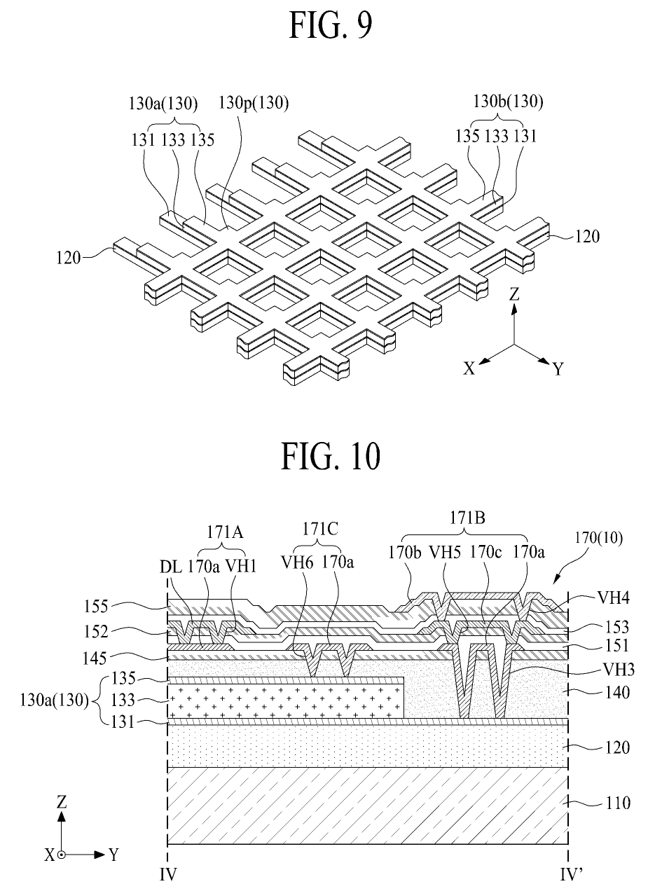

The plurality of thin-film transistors TFT may be disposed in each of the plurality of pixel areas and electrically connected to adjacent data lines DL and adjacent gate lines GL. The plurality of thin-film transistors TFT may be formed (or disposed) on the planarization layer 140 (or buffer layer 145) to overlap the vibration generating part 130. The vibration generating part 130 may include protrusions 130p (also shown in FIGS. 8 and 9) overlapping the plurality of thin-film transistors TFT disposed in each of the plurality of pixel areas. The protrusions 130p of the vibration generating part 130 may have a larger size than the thin-film transistor areas provided in each of the plurality of pixel areas. For example, the thin-film transistors TFT may be disposed (or configured) on the protrusions 130p of the vibration generating part 130.

Each of the plurality of thin-film transistors TFT may be used as a driving element of the liquid crystal display apparatus. Each of the plurality of thin-film transistors TFT may include a gate electrode GE, a gate insulating layer 151, a semiconductor layer SCL, an interlayer insulating layer 152, a source electrode SE, and a drain electrode DE.

The gate electrode GE may be protruded from the gate line GL disposed on the base substrate 110. The gate electrode GE may be formed of a conductive material, for example, magnesium (Mg), aluminum (Al), nickel (Ni), chromium (Cr), molybdenum (Mo), tungsten (W), gold (Au), or alloys thereof, or the like, but is not limited thereto.

The gate insulating layer 151 may be formed to cover the gate line GL and the gate electrode GE. The gate insulating layer 151 may be formed of an inorganic insulating material.

The semiconductor layer SCL may be formed (or disposed) on the gate insulating layer 151 to overlap (or correspond) the gate electrode GE. The semiconductor layer SCL may form a channel for current flow between the source electrode SE and the drain electrode DE when a voltage is applied to the gate electrode GE. For example, the semiconductor layer SCL may be made of polysilicon (p-Si), amorphous silicon (a-Si), or an oxide semiconductor, but is not limited thereto.

The interlayer insulating layer 152 may be formed (or disposed) to cover the gate insulating layer 151 and the gate electrode GE. The interlayer insulating layer 152 may be made of an inorganic insulating material.

Each of the source electrode SE and the drain electrode DE may be formed (or disposed) on the interlayer insulating layer 152 to overlap (or correspond) a portion of the active layer 121.

The source electrode SE and the drain electrode DE may be electrically connected to the semiconductor layer SCL through via holes formed in the interlayer insulating layer 152. The source electrode SE may be electrically connected to a source region of the semiconductor layer SCL through a source via hole formed in the interlayer insulating layer 152 on the source region of the semiconductor layer SCL. The drain electrode DE may be electrically connected to a drain region of the semiconductor layer SCL through a drain via hole formed in the interlayer insulating layer 152 on the drain region of the semiconductor layer SCL. For example, the drain electrode DE may be protruded from the data line DL disposed on the base substrate 110. The source electrode SE and the drain electrode DE may be formed of a conductive material, for example, magnesium (Mg), aluminum (Al), nickel (Ni), chromium (Cr), molybdenum (Mo), tungsten (W), gold (Au), or alloys thereof, or the like, but are not limited thereto.

The pixel array layer 150 may further include a passivation layer 153 and a protective layer 154.

The passivation layer 153 may be formed (or disposed) on the base substrate 110 to cover the plurality of thin-film transistors TFT. The passivation layer 153 may be an insulating layer configured to protect the plurality of thin-film transistors TFT and may be made of an inorganic material, but is not limited thereto. In another example, the passivation layer 153 may be omitted.

The protective layer 154 may be formed (or disposed) to cover the plurality of thin-film transistors TFT or the passivation layer 153. The protective layer 154 may be an insulating layer for forming (or configuring) a flat surface on the plurality of thin-film transistors TFT or the passivation layer 153. The protective layer 154 may be a planarization layer, a second planarization layer, or an overcoat layer. The protective layer 154 may be made of an organic material. The protective layer 154 may be configured as a single layer or a multilayer of polyimide or photo-acrylic, but is not limited thereto.

The common electrode CE may be formed (or disposed) on the protective layer 154. The common electrode CE may be electrically connected to a corresponding touch line TL among a plurality of touch lines TL. For example, the plurality of touch lines TL may be formed (or disposed) together with the data lines DL, but is not limited thereto. The plurality of touch lines TL may be formed (or disposed) on the interlayer insulating layer 152 to overlap the vibration generating part 130.

The common electrode CE may be divided into a plurality of touch electrodes TE (or a plurality of common electrode blocks) overlapping one or more among the plurality of pixel areas. One common electrode CE or one touch electrode TE may be commonly formed (or disposed) in two or more pixels SP. The plurality of touch electrodes TE may configure a touch element based on a self-capacitance method, but is not limited thereto.

The pixel array layer 150 may further include an insulating layer 155. The insulating layer 155 may be formed (or disposed) on the protective layer 154 to cover the common electrode CE. The insulating layer 155 may be made of an inorganic insulating material or an organic insulating material.

The pixel electrode PE may be formed (or disposed) on the insulating layer 155 of each of the plurality of pixel areas. For example, the pixel electrode PE may be formed on a rear (or bottom) surface of the insulating layer 155. The pixel electrode PE may be formed on the insulating layer 155 to overlap the common electrode CE in each of the plurality of pixel areas. The pixel electrode PE may overlap the common electrode CE with respect to the insulating layer 155 therebetween. For example, the common electrode CE may overlap the plurality of pixel electrodes PE formed in each of the plurality of pixel areas.

The pixel electrode PE may be electrically connected to the source electrode SE of a corresponding thin-film transistor TFT. The pixel electrode PE may be electrically connected to the source electrode SE of the corresponding thin-film transistor TFT through an electrode contact hole ECH which is formed at the insulating layer 155, the protective layer 154, and the passivation layer 153. In FIG. 5, the pixel electrode PE may be electrically connected to the source electrode SE of the TFT, but is not limited thereto. The pixel electrode PE may be electrically connected to the drain electrode DE of the thin-film transistor TFT, in which case, the source electrode SE of the thin-film transistor TFT is electrically connected to the data line DL.

As depicted in FIG. 4, the pixel electrode PE may be formed (or configured) to have a plurality of slits SL. For example, the pixel electrode PE may be formed (or configured) in a straight shape or in at least one or more curved (or bent) shape (for example, a zigzag shape).

According to another embodiment of the present disclosure, the common electrode CE may have a plurality of slits SL, and the pixel electrode PE may be formed (or disposed) to have a single-electrode structure within the pixel area.

The common electrode CE may be electrically connected to a corresponding touch line TL among the plurality of touch lines TL through a line connection pattern LCP which is formed together with the pixel electrode PE. The line connection pattern LCP may be formed (or disposed) to have an island shape on the insulating layer 155 together with the pixel electrode PE. The line connection pattern LCP may be connected (or directly connected) to a portion of the common electrode CE which is disposed on a corresponding touch line TL and electrically connected to the corresponding touch line TL through a line contact hole LCH formed at the insulating layer 155, the protective layer 154, and the passivation layer 153. Accordingly, the common electrode CE may receive a common voltage or a touch driving signal through the corresponding touch line TL and the line connection pattern LCP.

Each of the common electrode CE and the pixel electrode PE may be made of a transparent conductive material. For example, the transparent conductive material may include tin oxide, indium tin oxide, indium zinc oxide, or indium zinc tin oxide, or the like, but is not limited thereto.

The pixel array layer 150 may further include a first alignment layer 156. The first alignment layer 156 may be formed to set a pre-tilt angle of liquid crystal molecules 310. For example, the first alignment layer 156 may include fine grooves formed by a rubbing process.

The rear substrate 200 may include a second base substrate 210 and a color filter layer 230.

The second base substrate 210 may be made of glass or a transparent plastic. The second base substrate 210 may include a front (or top) surface 210a and a rear (or bottom) surface 210b. The rear surface 210b of the second base substrate 210 may correspond to a rear surface of the liquid crystal display panel 10.

The color filter layer 230 may be formed (or disposed) at the front surface 210a of the second base substrate 210. The color filter layer 230 may include color filters 231, 233, and 235 corresponding to each of the plurality of pixel areas. For example, the color filter layer 230 may include a red color filter 231, a green color filter 233, and a blue color filter 235.

Edge portions of each of the red color filter 231, the green color filter 233, and the blue color filter 235 may overlap each other. For example, one end edge portion of the red color filter 231 may be covered by the green color filter 233, and another end edge portion of the red color filter 231 may be covered by the blue color filter 235. Thus, in this case, one end edge portion of the red color filter 231 may overlap the green color filter 233, another end edge portion of the red color filter 231 may overlap the green color filter 233 in a third direction Z (or thickness direction).

The rear substrate 200 may further include a second alignment layer 250. The second alignment layer 250 may be formed to set a pre-tilt angle of the liquid crystal molecules 310. For example, the second alignment layer 250 may include fine grooves formed by a rubbing process.

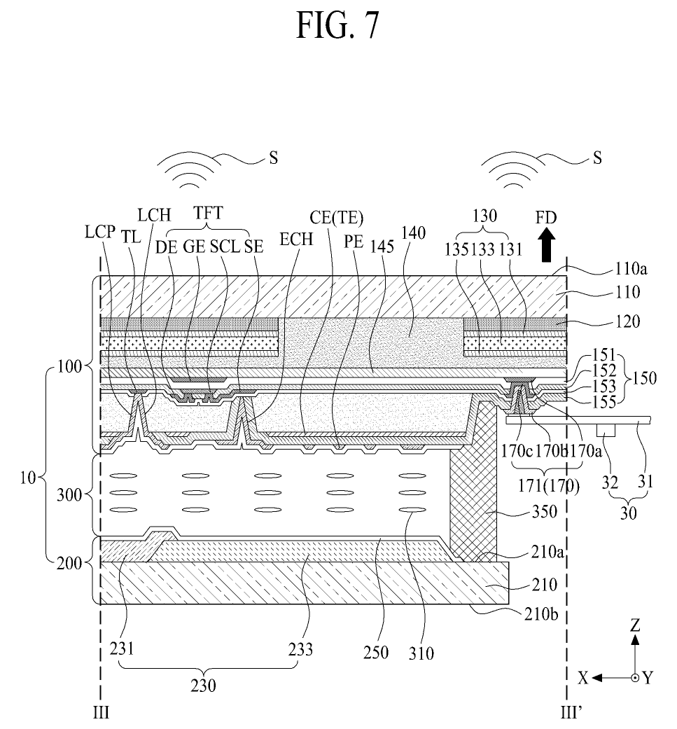

The front substrate 100 and the rear substrate 200 may be bonded together with respect to the liquid crystal layer 300 disposed therebetween by the sealant 350 (see FIG. 7). For example, the rear substrate 200 may be bonded to the remaining portion (or a first area) of the front substrate 100, except for one side edge portion (or a second area), with the liquid crystal layer 300 therebetween by the sealant 350.

The sealant 350 may be formed (or disposed) along an edge portion of the rear substrate 200 in the third direction Z. The sealant 350 may be formed to overlap a portion of the first and second alignment layers 156 and 250.

The liquid crystal layer 300 may be interposed (or filled) between the front substrate 100 and the rear substrate 200. The liquid crystal layer 300 may be filled into a space surrounded by the sealant 350. The liquid crystal layer 300 may be made of a liquid crystal in which an alignment direction of the liquid crystal molecules changes according to an electric field which is formed by the data voltage applied to the pixel electrode PE and the common voltage applied to the common electrode CE for each pixel.

In each of the plurality of pixels SP, when the common voltage is applied to the common electrode CE, and the data voltage is applied to the pixel electrode PE through the thin-film transistor TFT, a fringe field is formed between the pixel electrode PE and the common electrode CE through the slit SL of the pixel electrode PE, the liquid crystal molecules 310 of the liquid crystal layer 300 are driven by the fringe field, and since a light transmittance that transmits the display area from the backlight unit is changed according to the driving (or rotation) degree of the liquid crystal molecules 310, an image may be displayed according to the amount of light for each pixel SP.

Since the liquid crystal display apparatus configures a screen of the front substrate 100, and it is necessary to prevent or minimize reflection of external light by the metal lines (or metal layers) disposed (or configured) at the front substrate 100. To this end, the liquid crystal display panel 10 or the front substrate 100 may further include a reflection reducing part 120.

The reflection reducing part 120 may be formed (or configured) at the front (or top) substrate 100 to block or absorb the external light incident through the base substrate 110 of the front substrate 100. For example, the reflection reducing part 120 may be an anti-reflection part, a light-blocking part, a light-absorbing part, a light-absorbing patterned layer, or a high heat-resistant black matrix, but is not limited thereto.

The reflection reducing part 120 may be disposed (or interposed) between the base substrate 110 of the front substrate 100 and the vibration generating part 130. The reflection reducing part 120 may be formed (or disposed) to be in direct contact with the rear (or bottom) surface 110b of the base substrate 110. The vibration generating part 130 may be disposed (or configured) on the reflection reducing part 120. For example, the first electrode layer 131 of the vibration generating part 130 may be disposed (or configured) on the reflection reducing part 120 and may be in direct contact with the reflection reducing part 120.

The reflection reducing part 120 may be formed (or configured) to have a same shape as the vibration generating part 130 in a plan view. For example, the reflection reducing part 120 may be formed to have a same width, a same size, and a same planar shape as the vibration generating part 130.

The reflection reducing part 120 may be formed (or disposed) to overlap each of the plurality of gate lines GL and data lines DL and may block or absorb light incident on each of the plurality of gate lines GL and the plurality of data lines DL. The reflection reducing part 120 may be formed (or disposed) to overlap each of the plurality of touch lines TL and the plurality of thin-film transistors TFT and may block or absorb light incident on each of the plurality of touch lines TL and the plurality of thin-film transistors TFT. For example, the reflection reducing part 120 may have a mesh shape corresponding to the remaining areas except for the opening region of each of the plurality of pixel areas.

The reflection reducing part 120 may be made of a material capable of blocking or absorbing light. For example, the reflection reducing part 120 may be made of an oxide-based black dye or a high heat-resistant black resin, or the like. For example, the reflection reducing part 120 may be made of a black material, polyamide, or a light-absorbing material. For example, the light-absorbing material may include amorphous silicon (a-Si). The amorphous silicon (a-Si) may have a high light absorption rate and is used to convert solar energy into electrical energy, and have a characteristic that a light absorption rate is approximately 100 times higher than that of crystalline silicon. For example, the high heat-resistant black resin of the reflection reducing part 120 may be configured based on carbon black surface-treated with silicon (Si) and may include a silicon-based oligomer, a multifunctional monomer, a solvent, and a photo-initiator, or the like, but is not limited thereto.

The liquid crystal display panel 10 and the liquid crystal display apparatus including the same may vibrate based on the vibration of the vibration generating part 130 and may generate (or output) one or more of the sound S or the vibration. The liquid crystal display apparatus may use an entire surface of the front substrate 100 or the liquid crystal display panel 10 as a vibration plate for generating a sound, and thus, may form a wide sound field and may output the sound S of high-quality without distortion toward the front direction FD of the liquid crystal display panel 10. Furthermore, the liquid crystal display apparatus according to an embodiment may provide a haptic texture and/or a haptic feedback vibration to a user based on a haptic vibration of the vibration generating part 130 corresponding to a touch of user. Moreover, the liquid crystal display apparatus according to an embodiment may provide a speaker-integrated liquid crystal display panel 10 capable of displaying an image while outputting the sound S, and may be slimmed and lightened, and entire design aesthetics may be improved.

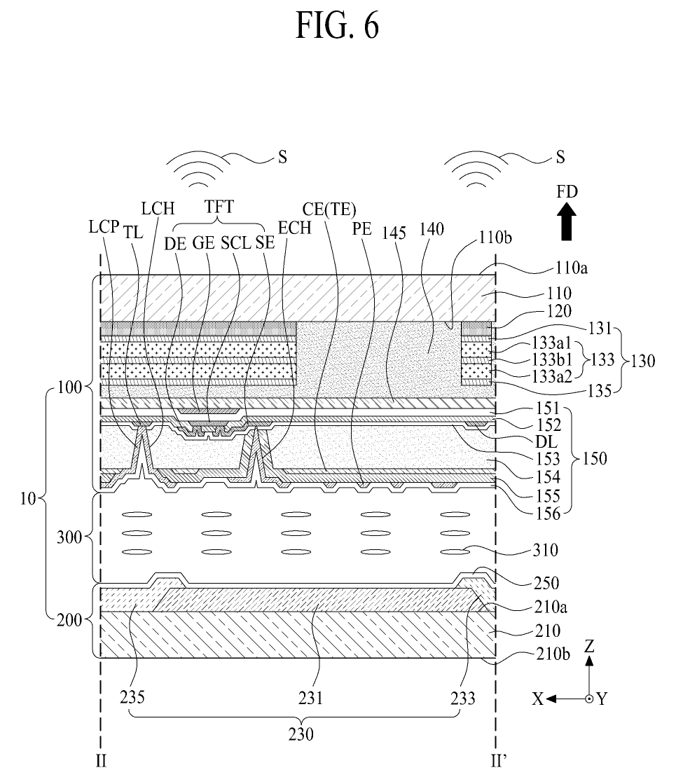

FIG. 6 is another schematic cross-sectional view taken along line II–II’ of FIG. 4. FIG. 6 illustrates an embodiment where the vibration generating part described above with reference to FIGS. 1 to 5 has been modified. In the following description, therefore, the vibration generating part and relevant elements will be only described, the other elements may be referred to by same reference numerals as FIGS. 4 and 5, and thus, repetitive descriptions are omitted.

Referring to FIG. 6, in the liquid crystal display panel 10 or the liquid crystal display apparatus according to an embodiment of the present disclosure, the piezoelectric vibration layer 133 of the vibration generating part 130 may include two or more piezoelectric layers 133a1 and 133a2 and one or more intermediate electrode layers 133b1.

The piezoelectric vibration layer 133 of the vibration generating part 130 according to another embodiment of the present disclosure may include a first piezoelectric layer 133a1, a second piezoelectric layer 133a2, and an intermediate electrode layer 133b1.

The first piezoelectric layer 133a1 may be disposed on the first electrode layer 131. The first piezoelectric layer 133a1 may be stacked (or coupled) on the first electrode layer 131 to have a same shape as the first electrode layer 131. The first piezoelectric layer 133a1 may be in direct contact with the first electrode layer 131.

The second piezoelectric layer 133a2 may be disposed (or interposed) between the first piezoelectric layer 133a1 and the second electrode layer 135. The second piezoelectric layer 133a2 may be stacked (or coupled) on the first piezoelectric layer 133a1 to have a same shape as the first piezoelectric layer 133a1. The second piezoelectric layer 133a2 may be in direct contact with the second electrode layer 135.

The intermediate electrode layer 133b1 may be disposed (or interposed) between the first piezoelectric layer 133a1 and the second piezoelectric layer 133a2. The intermediate electrode layer 133b1 may be configured (or stacked) on the first piezoelectric layer 133a1. The intermediate electrode layer 133b1 may be stacked (or coupled) on the first piezoelectric layer 133a1 to have a same shape as the first piezoelectric layer 133a1. The intermediate electrode layer 133b1 may be in direct contact with the first piezoelectric layer 133a1.

The second piezoelectric layer 133a2 may be configured (or stacked) on the intermediate electrode layer 133b1. The second piezoelectric layer 133a2 may be in direct contact with the intermediate electrode layer 133b1.

The first piezoelectric layer 133a1 and the second piezoelectric layer 133a2 may include a piezoelectric material. The intermediate electrode layer 133b1 may be made of a same conductive material as the first electrode layer 131 and the second electrode layer 135.

The first piezoelectric layer 133a1 and the second piezoelectric layer 133a2 may be polarized to displace (or vibrate or drive) in a same direction.

The first electrode layer 131 and the second electrode layer 135 may receive a first vibration driving signal. The intermediate electrode layer 133b1 may receive a second vibration driving signal different from the first vibration driving signal. For example, the first vibration driving signal may be a vibration driving signal having a positive polarity, and the second vibration driving signal may be a vibration driving signal having a negative polarity, but is not limited thereto.

The vibration generating part 130 according to another embodiment of the present disclosure includes two or more piezoelectric layers 133a1 and 133a2, and thus, displacement or amplitude displacement may be maximized or increased, thereby maximizing or increasing the displacement (or a bending force or a driving force) or the amplitude displacement of the front substrate 100 or the liquid crystal display panel 10. Accordingly, a sound output characteristic and/or a sound pressure characteristic of the low-pitched sound band generated based on the vibration of the front substrate 100 or the liquid crystal display panel 10 may be improved.

FIG. 7 is a schematic cross-sectional view taken along line III–III’ of FIG. 3. FIG. 7 is a diagram illustrating the pad part described above with reference to FIGS. 1 to 6. In the following description, therefore, the pad part and relevant elements will be only described, the other elements may be referred to by same reference numerals as FIGS. 1 to 6, and thus, repetitive descriptions are omitted.

Referring to FIGS. 3 and 7, in the liquid crystal display panel 10 or the liquid crystal display apparatus according to an embodiment of the present disclosure, the pad part 170 may include a plurality of pads 171.

The plurality of pads 171 may be disposed to have a predetermined interval along a length direction of the gate line GL. A first group of the plurality of pads 171 may be electrically connected to each of the plurality of data lines DL. A second group of the plurality of pads 171 may be electrically connected to the gate control signal line GCL. A third group of the plurality of pads 171 may be electrically connected to the first electrode layer 131 and the second electrode layer 135 of the vibration generating part 130, respectively.

Each of the plurality of pads 171 may include a pad electrode line 170a and a pad electrode 170b.

The pad electrode line 170a may be formed (or disposed) on the buffer layer 145. The pad electrode line 170a may be formed (or disposed) together with the gate lines GL. The pad electrode line 170a may be formed (or disposed) to be electrically connected to any one of the first electrode layer 131 and the second electrode layer 135 of the vibration generating part 130, the plurality of data lines DL, and the gate control signal line GCL.

The pad electrode 170b may be formed (or disposed) on the insulating layer 155 of the pixel array layer 150 so as to overlap a portion of the pad electrode line 170a. The pad electrode 170b may be electrically connected to the portion of the pad electrode line 170a through a via hole which is formed at the insulating layer 155, the passivation layer 153, the interlayer insulating layer 152, and the gate insulating layer 151 of the pixel array layer 150. The pad electrode 170b may be formed (or disposed) together with the pixel electrode PE.

Each of the plurality of pads 171 may further include an intermediate pad electrode 170c.

The intermediate pad electrode 170c may be disposed (or interposed) between the portion of the pad electrode line 170a and the pad electrode 170b. The intermediate pad electrode 170c may be formed (or disposed) on the interlayer insulating layer 152 and may be electrically connected to the portion of the pad electrode line 170a through a via hole which is formed at the interlayer insulating layer 152 and the gate insulating layer 151. The intermediate pad electrode 170c may be formed (or disposed) together with the data lines DL.

The pad electrode 170b may be electrically connected to the intermediate pad electrode 170c through a via hole which is formed at the insulating layer 155 and the passivation layer 153. Accordingly, the pad electrode 170b may be electrically connected to the pad electrode line 170a through the intermediate pad electrode 170c.

Each of the plurality of pads 171 may be electrically connected to the flexible circuit film 31 of the panel driving circuit 30. The flexible circuit film 31 may be attached to the plurality of pads 171 which are disposed on the substrate 100 by a film attachment process using an anisotropic conductive film.

In the liquid crystal display panel 10 or the liquid crystal display apparatus, the vibration generating part 130 may be formed (or disposed) to overlap the pad part 170. The vibration generating part 130 may be formed (or disposed) between the front substrate 100 and the pad part 170. Accordingly, the non-display area NDA (or second area) of the front substrate 100 may be utilized as a vibration area (or sound output area) that generates one or more of the sound or the vibration based on the vibration of the vibration generating part 130.

FIG. 8 is a schematic plan view illustrating a portions of each of a vibration generating part and a pad part. FIG. 9 is a schematic perspective view illustrating a portion of the vibration generating part illustrated in FIG. 8. FIG. 10 is a schematic cross-sectional view taken along line IV–IV’ of FIG. 8.

Referring to FIGS. 8, 9, and 10, the vibration generating part 130 may include a plurality of first lines 130a and a plurality of second lines 130b.

The plurality of first lines 130a may overlap each of the plurality of data lines DL in a plan view. The plurality of first lines 130a may have a line width relatively wider than each of the plurality of data lines DL in a plan view. The plurality of first lines 130a may be disposed (or interposed) between each of the plurality of data lines DL and the reflection reducing part 120.

The plurality of second lines 130b may overlap each of the plurality of gate lines GL and may intersect the plurality of first lines 130a. The plurality of second lines 130b may have a line width relatively wider than each of the plurality of gate lines GL in a plan view. The plurality of second lines 130b may be disposed (or interposed) between each of the plurality of gate lines GL and the reflection reducing part 120.

The plurality of first lines 130a and the plurality of second lines 130b may be disposed on a same layer over the reflection reducing part 120. The plurality of first lines 130a and the plurality of second lines 130b may be electrically connected to each other in intersection regions (or intersection portions). For example, the plurality of first lines 130a and the plurality of second lines 130b may be disposed on a same layer so as to have a mesh shape connected to each other.

The vibration generating part 130 may further include a plurality of protrusions 130p.

Each of the plurality of protrusions 130p may be protruded from the intersection portions of the plurality of first lines 130a and the plurality of second lines 130b and may overlap the thin-film transistors. Each of the plurality of protrusions 130p may be disposed (or configured) under the thin-film transistors which is disposed in the pixel areas.

Each of the plurality of first lines 130a, the plurality of second lines 130b, and the plurality of protrusions 130p may include the first electrode layer 131, the piezoelectric vibration layer 133, and the second electrode layer 135, as described above with reference to FIG. 4, and thus, repetitive descriptions are omitted.

In the vibration generating part 130, an end portion of each of the plurality of first lines 130a may be disposed in the pad part 170 (or pad area). A portion of the first electrode layer 131 which is disposed on the end portion of each of the plurality of first lines 130a may be exposed for electrical connection with the pad part 170. For example, both the piezoelectric vibration layer 133 and the second electrode layer 135 disposed over the first electrode layer 131 which is formed at the end portion of each of the plurality of first lines 130a may be removed, and thus, in each of the plurality of first lines 130a, the portion of the first electrode layer 131 may be not covered by the piezoelectric vibration layer 133 and the second electrode layer 135, but may be covered by the planarization layer 140.

According to another embodiment of the present disclosure, the liquid crystal display panel may include a plurality of vibration areas.

The liquid crystal display panel 10 may include a left vibration area and a right vibration area. In this case, each of the plurality of second lines 130b may be disconnected (or separated) at a boundary portion between the left vibration area and the right vibration area of the liquid crystal display panel. Accordingly, the vibration generating part 130 disposed in the left vibration area of the liquid crystal display panel may output a left sound based on the vibration, and the vibration generating part 130 disposed in the right vibration area of the liquid crystal display panel may output a right sound based on the vibration.

In another embodiment, the liquid crystal display panel 10 may further include an intermediate vibration area between the left vibration area and the right vibration area. In this case, each of the plurality of second lines 130b may be disconnected (or separated) at a first boundary portion between the left vibration area and the intermediate vibration area and at a second boundary portion between the intermediate vibration area and the right vibration area. Accordingly, the vibration generating part 130 disposed in the left vibration area of the liquid crystal display panel may output the left sound based on the vibration, the vibration generating part 130 disposed in the right vibration area of the liquid crystal display panel may output the right sound based on the vibration, and the vibration generating part 130 disposed in the intermediate vibration area of the liquid crystal display panel may output a center sound based on the vibration.

The pad part 170 may include a plurality of first pads 171A, a plurality of second pads 171B, and a plurality of third pads 171C.

The plurality of first pads 171A, the plurality of second pads 171B, and the plurality of third pads 171C may be disposed along the length direction of the gate lines GL to have a predetermined interval.

The plurality of first pads 171A may be electrically connected to each of the plurality of data lines DL. The plurality of first pads 171A may be individually and electrically connected to the plurality of data lines DL.

The plurality of second pads 171B may be electrically connected to the first electrode layer 131 of the vibration generating part 130. The plurality of second pads 171B may be electrically connected to the first electrode layer 131 of each of the plurality of first lines 130a. For example, the plurality of first lines 130a may be individually and electrically connected to the plurality of second pads 171B, in which case, the first vibration driving signal may be uniformly applied to an entire first electrode layer 131 of the vibration generating part 130.

The plurality of third pads 171C may be electrically connected to the second electrode layer 135 of the vibration generating part 130. The plurality of third pads 171C may be electrically connected to the second electrode layer 135 of each of the plurality of first lines 130a. For example, the plurality of first lines 130a may be individually and electrically connected to the plurality of third pads 171C, in which case, the second vibration driving signal may be uniformly applied to an entire second electrode layer 135 of the vibration generating part 130.

Each of the plurality of first pads 171A, the plurality of second pads 171B, and the plurality of third pads 171C may include a pad electrode line 170a and a pad electrode 170b.

The pad electrode line 170a of each of the plurality of first pads 171A may be electrically connected to a corresponding data line DL among the plurality of data lines DL. For example, the pad electrode line 170a of each of the plurality of first pads 171A may be disposed on the buffer layer 145, extended to overlap a portion of the data line DL, and electrically connected to a portion of the data line DL through a first via hole VH1 formed at the interlayer insulating layer 152 and the gate insulating layer 151. For example, the pad electrode line 170a of each of the plurality of first pads 171A may have a “┛”-shape in a plan view, but is not limited thereto.

The pad electrode 170b of each of the plurality of first pads 171A may be formed (or disposed) on the insulating layer 155 in the pad area and configured to be electrically connected to the pad electrode line 170a. The pad electrode 170b of each of the plurality of first pads 171A may be electrically connected to a portion of the pad electrode line 170a through a second via hole VH2 formed at the insulating layer 155, the passivation layer 153, the interlayer insulating layer 152, and the gate insulating layer 151. For example, the pad electrode 170b may be electrically connected to the portion of the pad electrode line 170a through the intermediate pad electrode 170c. Accordingly, a data signal applied to each of the plurality of first pads 171A may be applied to the corresponding data line through the pad electrode 170b and the pad electrode line 170a.

The pad electrode line 170a of the plurality of second pads 171B may be electrically connected to the first electrode layer 131 of the plurality of first lines 130a. For example, the pad electrode line 170a of the plurality of second pads 171B may be disposed on the buffer layer 145 and electrically connected to the first electrode layer 131 of the first lines 130a through a third via hole VH3 formed at the buffer layer 145 and the planarization layer 140. For example, the pad electrode line 170a of the plurality of second pads 171B may have a line shape in a plan view, but is not limited thereto.

The pad electrode 170b of the plurality of second pads 171B may be disposed to overlap an end of each of the plurality of first lines 130a. The pad electrode 170b of the plurality of second pads 171B may be disposed between the pad electrodes 170b of the first pads 171A and the pad electrodes 170b of the third pads 171C.

The pad electrode 170b of the plurality of second pads 171B may be formed (or disposed) on the insulating layer 155 of the pad area and configured to be electrically connected to the pad electrode line 170a. The pad electrode 170b of the plurality of second pads 171B may be electrically connected to a portion of the pad electrode line 170a through a fourth via hole VH4 formed at the insulating layer 155, the passivation layer 153, the interlayer insulating layer 152, and the gate insulating layer 151. For example, the pad electrode 170b may be electrically connected to the portion of the pad electrode line 170a through the intermediate pad electrode 170c. The intermediate pad electrode 170c may be electrically connected to the portion of the pad electrode line 170a through a fifth via hole VH5 formed at the interlayer insulating layer 152 and the gate insulating layer 151. Accordingly, the first vibration driving signal applied to the plurality of second pads 171B may be applied to an entire first electrode layer 131 of the vibration generating part 130 through the pad electrode 170b and the pad electrode line 170a.

The pad electrode line 170a of the plurality of third pads 171C may be electrically connected to the second electrode layer 135 of each of the plurality of first lines 130a. For example, the pad electrode line 170a of the plurality of third pads 171C may be disposed on the buffer layer 145, extended to overlap a portion of the second electrode layer 135 of the first lines 130a, and electrically connected to the second electrode layer 135 of the first lines 130a through a sixth via hole VH6 formed at the buffer layer 145 and the planarization layer 140. For example, the pad electrode line 170a of the one or more third pads 171C may have a “┗” shape in a plan view, but is not limited thereto.

The pad electrode 170b of the plurality of third pads 171C may be disposed on one side of the pad electrode 170b of the one or more second pads 171B. The pad electrode 170b of the plurality of third pads 171C may be formed (or disposed) on the insulating layer 155 of the pad area and electrically connected to the pad electrode line 170a. The pad electrode 170b of the plurality of third pads 171C may be electrically connected to a portion of the pad electrode line 170a through a seventh via hole VH7 formed at the insulating layer 155, the passivation layer 153, the interlayer insulating layer 152, and the gate insulating layer 151. For example, the pad electrode 170b may be electrically connected to the portion of the pad electrode line 170a through the intermediate pad electrode 170c. The intermediate pad electrode 170c may be electrically connected to the portion of the pad electrode line 170a through an eighth via hole formed at the interlayer insulating layer 152 and the gate insulating layer 151. Accordingly, the second vibration driving signal applied to the one or more third pads 171C may be applied to an entire second electrode layer 135 of the vibration generating part 130 through the pad electrode 170b and the pad electrode line 170a.

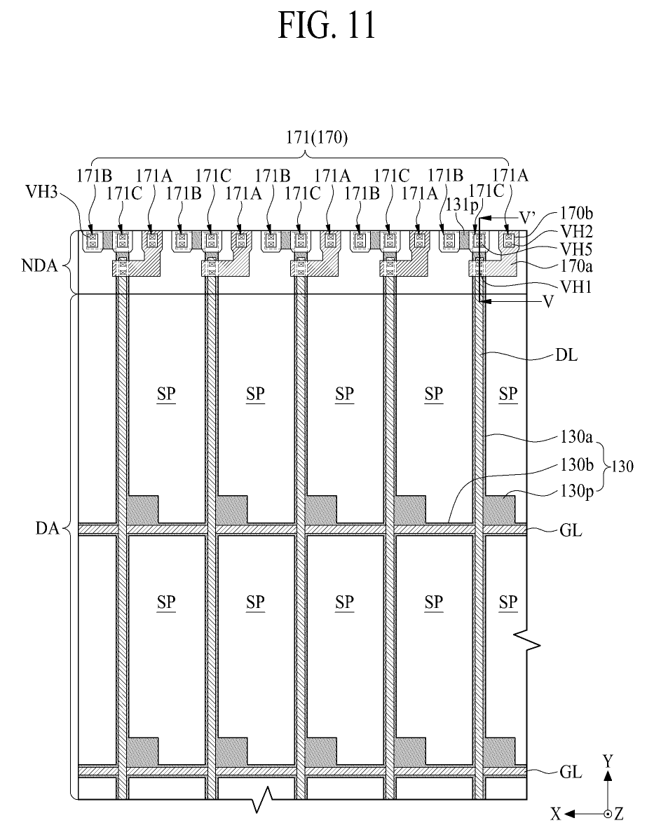

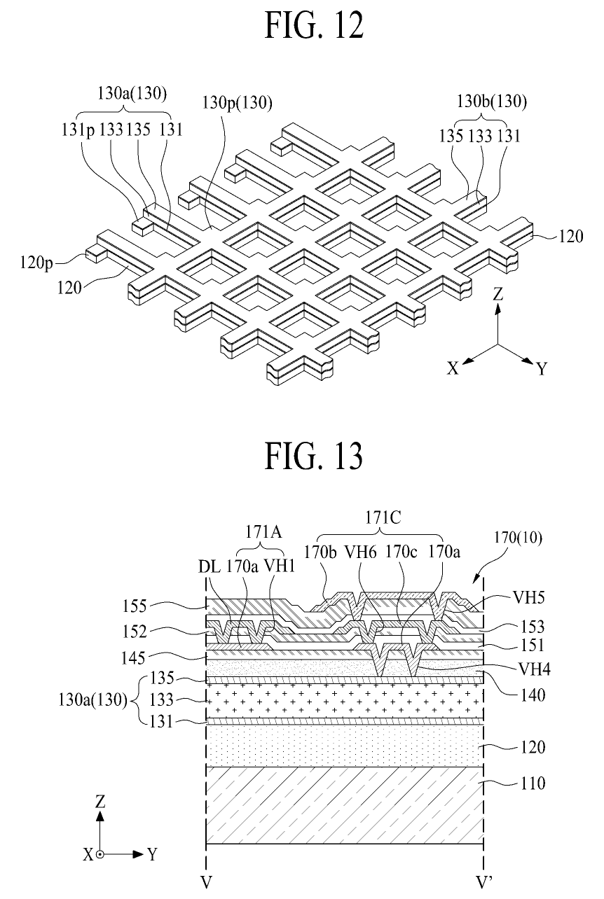

FIG. 11 is a schematic plan view illustrating a portion of each of a vibration generating part and a pad part according to another embodiment of the present disclosure. FIG. 12 is a schematic perspective view illustrating a portion of the vibration generating part illustrated in FIG. 11. FIG. 13 is a schematic cross-sectional view taken along line V–V’ of FIG. 11. FIGS. 11, 12, and 13 may illustrate an embodiment where a structure of the first line of the pad part and the vibration generating part described above with reference to FIGS. 8, 9, and 10 have been modified. In the following description, therefore, only modified elements will be described, the other elements may be referred to by same reference numerals as FIGS. 8, 9, and 10, and thus, repetitive descriptions are omitted. Therefore, descriptions above with reference to FIGS. 8, 9, and 10 may be included in descriptions of FIGS. 11, 12, and 13.

Referring to FIGS. 11, 12, and 13, in the vibration generating part 130 according to another embodiment of the present disclosure, each of the first electrode layer 131, the piezoelectric vibration layer 133, and the second electrode layer 135 of each of the plurality of first lines 130a may be formed (or disposed) to have a same line width and a same length.

Each of the plurality of first lines 130a may include an electrode protrusion 131p protruded from the first electrode layer 131.

The electrode protrusion 131p may be exposed without being covered by the piezoelectric vibration layer 133 and the second electrode layer 135. For example, the piezoelectric vibration layer 133 and the second electrode layer 135 disposed on the electrode protrusion 131p may be removed. Accordingly, the first electrode layer 131 and the second electrode layer 135 of the plurality of first lines 130a may be disposed in parallel to each other in a plan view.

The electrode protrusion 131p may be protruded (or extended) from one side of an end portion of the first electrode layer 131. For example, the end portion of the first electrode layer 131 of each of the plurality of first lines 130a may have a “┓”-shape or a “┤”-shape due to the electrode protrusion 131p in a plan view.

The reflection reducing part 120 may include an extension portion 120p overlapping the electrode protrusion 131p in the third direction Z (or thickness direction). For example, an end portion of the reflection reducing part 120 overlapping each of the plurality of first lines 130a may have a “┓”-shape or a “┤”-shape due to the extension portion 120p in a plan view.

The pad part 170 according to another embodiment of the present disclosure may include a plurality of first pads 171A, a plurality of second pads 171B, and a plurality of third pads 171C.

Each of the plurality of first pads 171A, the plurality of second pads 171B, and the plurality of third pads 171C may include a pad electrode line 170a and a pad electrode 170b.

The pad electrode line 170a of each of the plurality of first pads 171A may be electrically connected to a corresponding data line DL among the plurality of data lines DL. For example, the pad electrode line 170a of each of the plurality of first pads 171A may be disposed on the buffer layer 145, extended to overlap a portion of the data line DL, and electrically connected to the portion of the data line DL through a first via hole VH1 formed at the interlayer insulating layer 152 and the gate insulating layer 151. For example, the pad electrode line 170a of each of the plurality of first pads 171A may have a “┛”-shape in a plan view, but is not limited thereto.

The pad electrode 170b of each of the plurality of first pads 171A may be formed (or disposed) on the insulating layer 155 in the pad area and configured to be electrically connected to the pad electrode line 170a. The pad electrode 170b of each of the plurality of first pads 171A may be electrically connected to a portion of the pad electrode line 170a through a second via hole VH2 formed at the insulating layer 155, the passivation layer 153, the interlayer insulating layer 152, and the gate insulating layer 151. For example, the pad electrode 170b may be electrically connected to the portion of the pad electrode line 170a through the intermediate pad electrode 170c. Accordingly, a data signal applied to each of the plurality of first pads 171A may be applied to a corresponding data line through the pad electrode 170b and the pad electrode line 170a.

The pad electrode line 170a of the plurality of second pads 171B may be electrically connected to the electrode protrusion 131p of the first electrode layer 131 of each of the plurality of first lines 130a. For example, the pad electrode line 170a of the plurality of second pads 171B may be disposed on the buffer layer 145 and electrically connected to the electrode protrusion 131p of the first electrode layer 131 of the first lines 130a through a via hole formed at the buffer layer 145 and planarization layer 140. For example, the pad electrode line 170a of the plurality of second pads 171B may have a line shape in a plan view, but is not limited thereto.

The pad electrode 170b of the plurality of second pads 171B may be disposed on one side of each of the plurality of first lines 130a. The pad electrode 170b of the plurality of second pads 171B may be disposed to overlap the electrode protrusion 131p of each of the plurality of first lines 130a.

The pad electrode 170b of the plurality of second pads 171B may be formed (or disposed) on the insulating layer 155 of the pad area and configured to be electrically connected to the pad electrode line 170a. The pad electrode 170b of the plurality of second pads 171B may be electrically connected to a portion of the pad electrode line 170a through a third via hole VH3 formed at the insulating layer 155, the passivation layer 153, the interlayer insulating layer 152, and the gate insulating layer 151. For example, the pad electrode 170b may be electrically connected to the portion of the pad electrode line 170a through the intermediate pad electrode 170c. The intermediate pad electrode 170c may be electrically connected to the portion of the pad electrode line 170a through a via hole formed at the interlayer insulating layer 152 and the gate insulating layer 151. Accordingly, the first vibration driving signal applied to the plurality of second pads 171B may be applied to an entire first electrode layer 131 of the vibration generating part 130 through the pad electrode 170b, the pad electrode line 170a, and the electrode protrusion 131p.

The pad electrode line 170a of the plurality of third pads 171C may be electrically connected to the second electrode layer 135 of a corresponding first line 130a among the plurality of first lines 130a. For example, the pad electrode line 170a of the plurality of third pads 171C may be disposed on the buffer layer 145, extended to overlap a portion of the second electrode layer 135 of the first lines 130a, and electrically connected to the second electrode layer 135 through a fourth via hole VH4 formed at the buffer layer 145 and the planarization layer 140. For example, the pad electrode line 170aof the plurality of third pads 171C may have a line shape in a plan view, but is not limited thereto.

The pad electrode 170b of the plurality of third pads 171C may be disposed to overlap an end of one or more first lines 130a among the plurality of first lines 130a. The pad electrode 170b of the plurality of third pads 171C may be disposed between the pad electrodes 170b of the first pads 171A and the pad electrodes 170b of the second pads 171B.

The pad electrode 170b of the plurality of third pads 171C may be formed (or disposed) on the insulating layer 155 of the pad area and configured to be electrically connected to the pad electrode line 170a. The pad electrode 170b of the plurality of third pads 171C may be electrically connected to a portion of the pad electrode line 170a through a fifth via hole VH5 formed at the insulating layer 155, the passivation layer 153, the interlayer insulating layer 152, and the gate insulating layer 151. For example, the pad electrode 170b may be electrically connected to the portion of the pad electrode line 170a through the intermediate pad electrode 170c. The intermediate pad electrode 170c may be electrically connected to the portion of the pad electrode line 170a through a sixth via hole VH6 formed at the interlayer insulating layer 152 and the gate insulating layer 151. Accordingly, the second vibration driving signal applied to one or more third pads 171C may be applied to an entire second electrode layer 135 of the vibration generating part 130 through the pad electrode 170b and the pad electrode line 170a.

According to another embodiment of the present disclosure, since the electrode protrusions 131p of the first electrode layer 131 and the second electrode layer 135 of each of the plurality of first lines 130a are disposed in parallel to each other, a width of the pad part 170 may be reduced, thereby reducing a width of the non-display area NDA in a plan view.

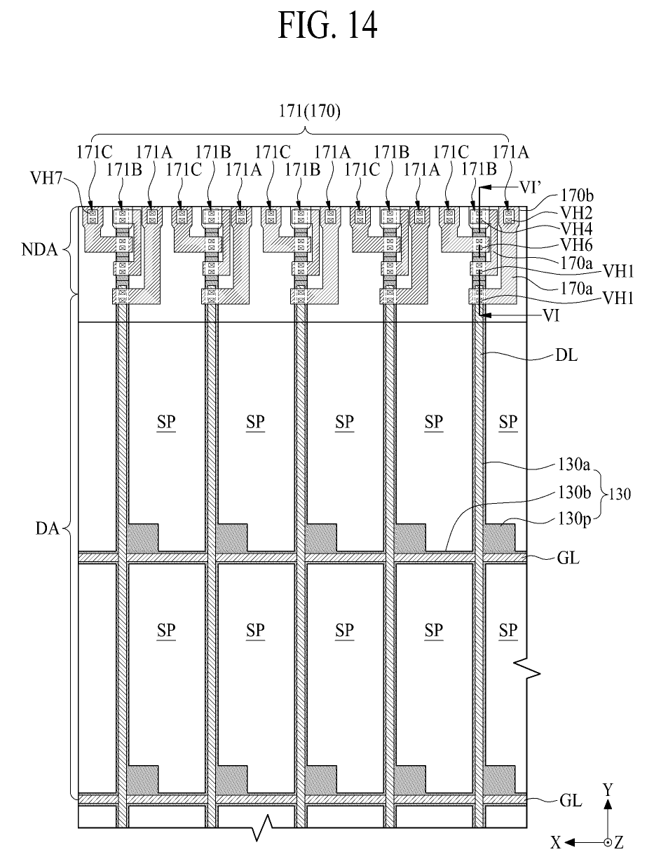

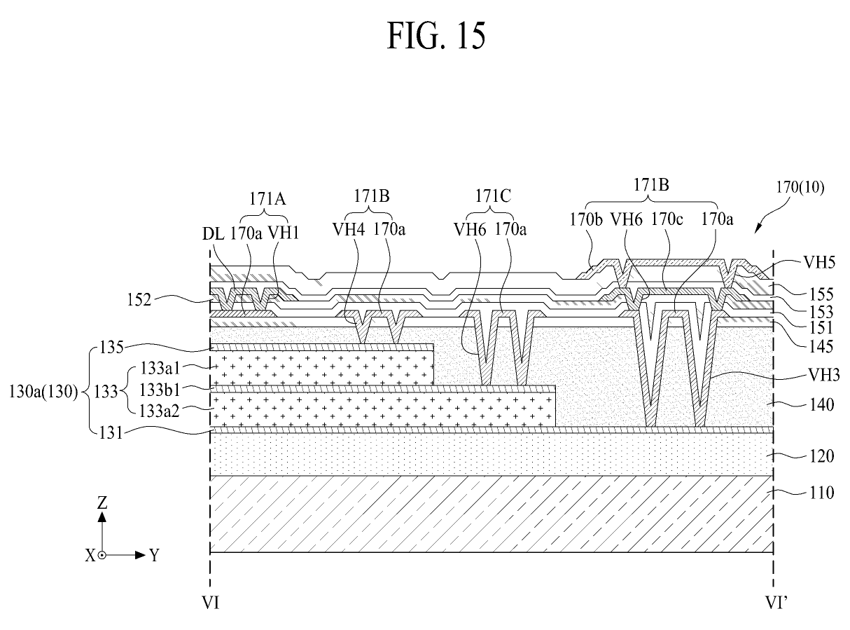

FIG. 14 is a schematic plan view illustrating a portion of each of a vibration generating part and a pad part according to another embodiment of the present disclosure. FIG. 15 is a schematic cross-sectional view taken along line VI–VI’ of FIG. 14. FIGS. 14 and 15 may illustrate an embodiment where a structure of the pad part and the vibration generating part described above with reference to FIGS. 8, 9, and 10 have been modified. In the following description, therefore, only modified elements will be described, the other elements may be referred to by same reference numerals as FIGS. 8, 9, and 10, and thus, repetitive descriptions are omitted. Therefore, descriptions above with reference to FIGS. 8, 9, and 10 may be included in descriptions of FIGS. 14 and 15.

Referring to FIGS. 14 and 15, in the vibration generating part 130 according to another embodiment of the present disclosure, the piezoelectric vibration layer 133 of the vibration generating part 130 may include two or more piezoelectric layers 133a1 and 133a2 and at least one intermediate electrode layer 133b1. For example, the vibration generating part 130 may include the first electrode layer 131, the first piezoelectric layer 133a1, the intermediate electrode layer 133b1, the second piezoelectric layer 133a2, and the second electrode layer 135.

Each of the first electrode layer 131, the first piezoelectric layer 133a1, the intermediate electrode layer 133b1, the second piezoelectric layer 133a2, and the second electrode layer 135 of each of the plurality of first lines 130a may be formed (or disposed) to have a same line width and a same length.

An end portion of each of the plurality of first lines 130a may be disposed in the pad part 170 (or pad area). A portion of the first electrode layer 131 disposed on the end portion of each of the plurality of first lines 130a may be exposed for electrical connection with the pad part 170. For example, both the first piezoelectric layer 133a1, the intermediate electrode layer 133b1, the second piezoelectric layer 133a2, and the second electrode layer 135 which are disposed on the first electrode layer 131 formed at the end portion of each of the plurality of first lines 130a may be removed, and thus, a portion of the first electrode layer 131 in each of the plurality of first lines 130a may be covered by the planarization layer 140.

The first piezoelectric layer 133a1 and the intermediate electrode layer 133b1 of each of the plurality of first lines 130a may be spaced apart from the end of the first electrode layer 131. For example, the intermediate electrode layer 133b1 may be disposed between the first piezoelectric layer 133a1 and the second piezoelectric layer 133a2. A portion of the intermediate electrode layer 133b1 of each of the plurality of first lines 130a may be exposed for electrical connection with the pad part 170. For example, both the second piezoelectric layer 133a2 and the second electrode layer 135 which are disposed over the intermediate electrode layer 133b1 spaced apart from the end of the first electrode layer 131 of each of the plurality of first lines 130a, and thus, the portion of the intermediate electrode layer 133b1 in each of the plurality of first lines 130a may be covered by the planarization layer 140.

The intermediate electrode layer 133b1 of each of the plurality of first lines 130a may be exposed between the first electrode layer 131 and the second electrode layer 135, and may be covered by the planarization layer 140 without being covered by the second piezoelectric layer 133a2 and the second electrode layer 135.

The pad part 170 according to another embodiment of the present disclosure may include a plurality of first pads 171A, a plurality of second pads 171B, and a plurality of third pads 171C.

The plurality of first pads 171A, the plurality of second pads 171B, and the plurality of third pads 171C may be disposed along the length direction of the gate line GL to have the predetermined interval.

The plurality of first pads 171A may be electrically connected to each of the plurality of data lines DL. Each of the plurality of first pads 171A may be individually and electrically connected to the plurality of data lines DL.

The plurality of second pads 171B may be commonly and electrically connected to the first electrode layer 131 and the second electrode layer 135 of the vibration generating part 130. The plurality of second pads 171B may be commonly and electrically connected to the first electrode layer 131 and the second electrode layer 135 of each of the plurality of first lines 130a. For example, each of the plurality of first lines 130a may be individually and electrically connected to the plurality of second pads 171B, in which case, the first vibration driving signal may each be uniformly applied to an entire first electrode layer 131 and the second electrode layer 135 of the vibration generating part 130.

The plurality of third pads 171C may be electrically connected to the intermediate electrode layer 133b1 of the vibration generating part 130. The plurality of third pads 171C may be electrically connected to the intermediate electrode layer 133b1 of each of the plurality of first lines 130a. For example, each of the plurality of first lines 130a may be individually and electrically connected to the plurality of third pads 171C, in which case, the second vibration driving signal may be uniformly applied to an entire intermediate electrode layer 133b1 of the vibration generating part 130.

Each of the plurality of first pads 171A, the plurality of second pads 171B, and the plurality of third pads 171C may include a pad electrode line 170a and a pad electrode 170b.

The pad electrode line 170a of each of the plurality of first pads 171A may be electrically connected to a corresponding data line DL among the plurality of data lines DL. For example, the pad electrode line 170a of each of the plurality of first pads 171A may be disposed on the buffer layer 145, extended to overlap a portion of the data line DL, and electrically connected to the portion of the data line DL through a first via hole VH1 formed at the interlayer insulating layer 152 and the gate insulating layer 151. For example, the pad electrode line 170a of each of the plurality of first pads 171A may have a “┛”-shape in a plan view, but is not limited thereto.

The pad electrode 170b of each of the plurality of first pads 171A may be formed (or disposed) on the insulating layer 155 of the pad area and configured to be electrically connected to the pad electrode line 170a. The pad electrode 170b of each of the plurality of first pads 171A may be electrically connected to a portion of the pad electrode line 170a through a second via hole VH2 formed at the insulating layer 155, the passivation layer 153, the interlayer insulating layer 152, and the gate insulating layer 151. For example, the pad electrode 170b may be electrically connected to the portion of the pad electrode line 170a through the intermediate pad electrode 170c. Accordingly, a data signal applied to each of the plurality of first pads 171A may be applied to a corresponding data line through the pad electrode 170b and the pad electrode line 170a.

The pad electrode line 170a of the one or more second pads 171B may be commonly and electrically connected to the first electrode layer 131 and the second electrode layer 135 of one or more first lines 130a among the plurality of first lines 130a. For example, the pad electrode line 170a of the one or more second pads 171B may be disposed on the buffer layer 145 and electrically connected to the first electrode layer 131 of the first lines 130a through a third via hole VH3 formed at the buffer layer 145 and the planarization layer 140, while simultaneously being electrically connected to the second electrode layer 135 of the first lines 130a through a fourth via hole VH4. One side of the pad electrode line 170a of the second pads 171B may be electrically connected to the first electrode layer 131 of the first lines 130a through the third via hole VH3, and the other side of the second pads 171B may be electrically connected to the second electrode layer 135 of the first lines 130a through the fourth via hole VH4. An intermediate portion between the one side and the other side of the pad electrode line 170a of the second pads 171B may be disposed between the first lines 130a and the pad electrode line 170a of the first pads 171A. For example, the pad electrode line 170a of the plurality of second pads 171B may have a “L”-shape in a plan view, but is not limited thereto.

The pad electrode 170b of the one or more second pads 171B may be disposed to overlap the end of each of the plurality of first lines 130a. The pad electrode 170b of the plurality of second pads 171B may be disposed between the pad electrodes 170b of the first pads 171A and the pad electrodes 170b of the third pads 171C.

The pad electrode 170b of the plurality of second pads 171B may be formed (or disposed) on the insulating layer 155 of the pad area and configured to be electrically connected to the pad electrode line 170a. The pad electrode 170b of the plurality of second pads 171B may be electrically connected to a portion of the pad electrode line 170a through a fifth via hole VH5 formed at the insulating layer 155, the passivation layer 153, the interlayer insulating layer 152, and the gate insulating layer 151. For example, the pad electrode 170b may be electrically connected to the portion of the pad electrode line 170a through the intermediate pad electrode 170c. The intermediate pad electrode 170c may be electrically connected to the portion of the pad electrode line 170a through a sixth via hole VH6 formed at the interlayer insulating layer 152 and the gate insulating layer 151. Accordingly, the first vibration driving signal applied to the plurality of second pads 171B may be applied (or entirely applied) to each of the first electrode layer 131 and the second electrode layer 135 of the vibration generating part 130 through the pad electrode 170b and the pad electrode line 170a.

The pad electrode line 170a of the one or more third pads 171C may be electrically connected to the intermediate electrode layer 133b1 of each of the plurality of first lines 130a. For example, the pad electrode line 170a of the plurality of third pads 171C may be disposed on the buffer layer 145, extended to overlap a portion of the intermediate electrode layer 133b1 of the first line(s) 130a, and electrically connected to the intermediate electrode layer 133b1 of the first lines 130a through a sixth via hole VH6 formed at the buffer layer 145 and the planarization layer 140. For example, the pad electrode line 170a of the plurality of third pads 171C may have a “┗”-shape in a plan view, but is not limited thereto.

The pad electrode 170b of the plurality of third pads 171C may be disposed on one side of the pad electrode 170b of the plurality of second pads 171B. The pad electrode 170b of the plurality of third pads 171C may be formed (or disposed) on the insulating layer 155 of the pad area and configured to be electrically connected to the pad electrode line 170a. The pad electrode 170b of the one or more third pads 171C may be electrically connected to a portion of the pad electrode line 170a through a seventh via hole VH7 formed at the insulating layer 155, the passivation layer 153, the interlayer insulating layer 152, and the gate insulating layer 151. For example, the pad electrode 170bmay be electrically connected to the portion of the pad electrode line 170a through the intermediate pad electrode 170c. The intermediate pad electrode 170c may be electrically connected to the portion of the pad electrode line 170a through an eighth via hole formed at the interlayer insulating layer 152 and the gate insulating layer 151. Accordingly, the second vibration driving signal applied to one or more third pads 171C may be applied to an entire intermediate electrode layer 133b1 of the vibration generating part 130 through the pad electrode 170b and the pad electrode line 170a.

In one or more aspects, a liquid crystal display panel includes a front substrate configured to include a plurality of pixel areas, a rear substrate configured to include color filters corresponding to each of the plurality of pixel areas, and a liquid crystal layer between the front substrate and the rear substrate. The front substrate includes a base substrate, a vibration generating part disposed on the base substrate, a planarization layer configured to cover the vibration generating part, and a pixel array layer disposed on the planarization layer.

According to an embodiment of the present disclosure, a liquid crystal display panel configured to output a sound and a liquid crystal display apparatus including the same may be provided. Although a liquid crystal display panel and a liquid crystal layer have respectively been exemplarily discussed as a display panel and an electro-optical layer in the above embodiments, the inventive concepts are not limited thereto, and any type of display panels and electro-optical layers known in the art may be applicable to the aforementioned embodiments.

According to an embodiment of the present disclosure, a speaker-integrated liquid crystal display panel configured to output a sound while displaying an image, and a liquid crystal display apparatus including the same, may be provided. Accordingly, ESG (Environmental, Social, and Governance) performance may be realized through the effects of weight reduction and/or uni-materialization.

The liquid crystal display apparatus according to an embodiment of the present disclosure may provide a haptic texture and/or a haptic feedback vibration to a user based on a haptic vibration of the liquid crystal display panel corresponding to user touch.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A liquid crystal display panel, comprising:
a front substrate including a plurality of pixel areas;
a rear substrate including color filters corresponding to each of the plurality of pixel areas; and
a liquid crystal layer disposed between the front substrate and the rear substrate,
wherein the front substrate includes:
a base substrate;
a vibration generating part disposed on the base substrate;
a planarization layer covering the vibration generating part in a thickness direction; and
a pixel array layer disposed on the planarization layer.

2. The liquid crystal display panel of claim 1, wherein the vibration generating part includes a piezoelectric vibration layer having a piezoelectric material.

3. The liquid crystal display panel of claim 1, wherein the vibration generating part includes:
a first electrode layer disposed on the base substrate;
a piezoelectric vibration layer including a piezoelectric material and disposed on the first electrode layer; and
a second electrode layer disposed on the piezoelectric vibration layer.

4. The liquid crystal display panel of claim 1, wherein:
the pixel array layer includes a plurality of gate lines and a plurality of data lines disposed on the planarization layer and intersecting each other to define the plurality of pixel areas, and
the vibration generating part overlaps the plurality of gate lines and the plurality of data lines.

5. The liquid crystal display panel of claim 4, wherein the vibration generating part includes:
a plurality of first lines overlapping each of the plurality of data lines; and
a plurality of second lines overlapping each of the plurality of gate lines and intersecting the plurality of first lines.

6. The liquid crystal display panel of claim 5, wherein the plurality of first lines and the plurality of second lines are disposed on a same layer and have a mesh shape connected to each other.

7. The liquid crystal display panel of claim 5, wherein each of the plurality of first lines and the plurality of second lines includes:
a first electrode layer disposed on the base substrate;
a piezoelectric vibration layer including a piezoelectric material disposed on the first electrode layer; and
a second electrode layer disposed on the piezoelectric vibration layer.

8. The liquid crystal display panel of claim 7, wherein the pixel array layer further includes:
a plurality of thin-film transistors disposed in each of the plurality of pixel areas and electrically connected to adjacent data lines and adjacent gate lines;
a plurality of pixel electrodes disposed in each of the plurality of pixel areas and electrically connected to a corresponding thin-film transistor of the plurality of thin-film transistors; and
a common electrode overlapping the plurality of pixel electrodes.

9. The liquid crystal display panel of claim 8, wherein the common electrode is divided into a plurality of touch electrodes overlapping one or more of the plurality of pixel areas.

10. The liquid crystal display panel of claim 8, wherein:
the vibration generating part includes a plurality of protrusions that protrude from intersection portions of the plurality of first lines and the plurality of second lines and overlap each of the plurality of thin-film transistors; and
each of the plurality of protrusions includes the first electrode layer, the piezoelectric vibration layer, and the second electrode layer.

11. The liquid crystal display panel of claim 7, wherein the front substrate includes:
a first area overlapping the rear substrate;
a second area extending from the first area; and
a pad part disposed in the second area, and
wherein the vibration generating part overlaps the pad part.

12. The liquid crystal display panel of claim 11, wherein the pad part includes:
a plurality of first pads electrically connected to each of the plurality of data lines;
a plurality of second pads electrically connected to the first electrode layer of each of the plurality of first lines; and
a plurality of third pads electrically connected to the second electrode layer of each of the plurality of first lines.

13. The liquid crystal display panel of claim 12, wherein:
the vibration generating part further includes an electrode protrusion protruding from one side of the first electrode layer of each of the plurality of first lines; and
the plurality of second pads are electrically connected to the electrode protrusion.

14. The liquid crystal display panel of claim 11, wherein the piezoelectric vibration layer includes:
two or more piezoelectric layers disposed between the first electrode layer and the second electrode layer; and
at least one intermediate electrode layer disposed between the two or more piezoelectric layers.

15. The liquid crystal display panel of claim 14, wherein the pad part includes:
a plurality of first pads electrically connected to each of the plurality of data lines;
a plurality of second pads commonly and electrically connected to the first electrode layer and the second electrode layer of each of the plurality of first lines; and
a plurality of third pads electrically connected to the intermediate electrode layer of each of the plurality of first lines.

16. The liquid crystal display panel of claim 1, further comprising:
a base substrate disposed on the front substrate; and
a reflection reducing part disposed between the base substrate and the vibration generating part,
wherein the reflection reducing part comprises a light-blocking material and has a same shape as the vibration generating part in a plan view.

17. A display apparatus, comprising:
a display panel including:
a front substrate including a plurality of pixel areas;
a rear substrate including color filters corresponding to each of the plurality of pixel areas;
an electro-optical layer disposed between the front substrate and the rear substrate;
a backlight unit configured to irradiate light to the display panel; and
a panel driving circuit electrically connected to the display panel,
wherein the front substrate includes:
a base substrate;
a vibration generating part disposed on the base substrate;
a planarization layer to cover the vibration generating part in a thickness direction; and
a pixel array layer disposed on the planarization layer.

18. The display apparatus of claim 17, wherein:
the display panel further includes a reflection reducing part disposed between the base substrate and the vibration generating part; and
the reflection reducing part comprises a light-blocking material and has a same shape as the vibration generating part in a plan view.

19. The display apparatus of claim 17, wherein the panel driving circuit includes an amplifier circuit configured to apply a vibration driving signal to the vibration generating part disposed in the display panel.

20. The display apparatus of claim 19, wherein:
the vibration generating part is configured to be displaced based on the vibration driving signal; and
the front substrate is configured to vibrate based on the displacement of the vibration generating part to generate one or more of a sound and a haptic vibration.
